(19) United States
(12) Patent Application Publication
(10) Pub. No.: US 2022/0361984 A1
(43) Pub. Date: Nov. 17, 2022

(54) MAGNET-BASED ORTHODONTIC APPLIANCE

(71) Applicant: Pramod Philip, Buffalo, NY (US)

(72) Inventor: Pramod Philip, Buffalo, NY (US)

(21) Appl. No.: 17/744,037

(22) Filed: May 13, 2022

Related U.S. Application Data
(60) Provisional application No. 63/201,816, filed on May 14, 2021.

(51) Int. Cl. A61C 7/00; A61C 7/14; A61C 7/20; A61C 8/00; A61C 5/30

(52) U.S. Cl. CPC A61C 7/006; A61C 7/145; A61C 7/20; A61C 8/0096; A61C 5/30

(57) ABSTRACT

An orthodontic appliance is rigid to avoid significant flexing due to therapeutic magnetic forces. The orthodontic appliance is magnetically mountable on the lingual or palatal side of teeth of a patient. Magnetic or magnetizable targets are mounted only on the lingual or palatal side of the patient's teeth. Orthodontic components are obscured from view behind the patient's teeth. Orthodontic correction is provided with improved esthetics. Magnets and/or targets can be of custom, designed or selected shapes, including non-planar shapes, to provide a desired force vector.

The present application is based on and claims priority to U.S. Provisional Application Ser. No. 63/201,816 filed May 14, 2021, which is incorporated herein by reference in its entirety.

### FIELD

The present exemplary embodiments relate to orthodontic appliances. Embodiments include appliances for installation and operation on the lingual and palatal side of teeth of a patient.

### BACKGROUND

Traditionally metallic or non-metallic brackets are attached to the labial and/or lingual surfaces of the teeth and serve as handles or points of attachment. The brackets transfer force applied by various force elements such as an elastic recoil of the metallic or non-metallic arch wires, elastics made of natural rubber, elastomeric chains made of synthetic polymers, magnets or a combination of any of these. Also, removable appliances that use metallic wires and elastics or clear aligners based on the flexible properties of vacuum formed thermoplastic materials can be used in a sequential manner for orthodontic tooth movement.

For example, U.S. Pat. No. 9,775,687 to Hoyberg shows a secondary magnet 22 positioned below a tooth that has primary magnets attached on both a buccal and lingual side of the tooth allegedly arranged to be attracted to secondary magnet 22. It is suggested that the resulting attractive force will draw the tooth downward. Other arrangements where one or both of the primary magnets are repelled by the secondary magnet are also discussed (e.g., see column 6, lines 27-58). FIG. 12 shows an arrangement alleged to apply rotational torque to a tooth. FIG. 7 shows a magnetizable element 25 mounted on a mesial side of a tooth (covered by an aligner tray 34) and a secondary magnet 40 (see also FIGS. 8 and 9) mounted on a labial side of a secondary magnet holder 38. FIG. 14 also shows primary magnets 26 mounted on the lingual (or palatal) sides of respective molars with secondary magnets 40 apparently mounted on lingual sides of a secondary magnet holder. An aligner and magnet holder tray are not illustrated in FIG. 14 so that the magnets 26 and 40 can be more clearly seen (column 14, lines 37-39).

U.S. Pat. No. 9,498,302 to Patel discusses an orthodontic appliance for moving selected teeth of a patient. The appliance includes a hollow aligner shell that fits over a set of selected teeth and supports a series of tooth moving elements, such as magnets or metal engagement plates. FIGS. 10 and 12 of Patel show aligner shells 1020 (made of thermoplastic or suitable resin (see column 12, lines 55-56)) supporting metal engagement plates 1050 and magnets 1040 in positions relative to magnets or engagement plates mounted on selected teeth. For example, one metal engagement plate and magnet pair are illustrated on a lingual or palatal side of a tooth.

U.S. Patent Application Publication No. 2018/0071054 A1 by Ha discusses an apparatus and method for correcting orthodontic malocclusions. The Orthodontic appliance includes a body and one or more first magnets disposed on the body and arranged to provide either repulsive or attractive force between one or more second magnets disposed on a surface of a tooth. The appliances are attached to the subject's dental arch using one or more temporary anchor devices (TADs). Surgical guides are created using a computer model of the subject and are used to assist in placement and attachment of the TADs. The appliance 12 includes a body 18 having a general loop form configured to generally follow the contour and shape of the subject's teeth. The body 18 is formed to contact vertical surfaces of the teeth that are not being moved and provide a space or gap between the body and the front and/or back surfaces of the teeth that are being repositioned. The front wall of the body 18 that overlaps teeth not being repositioned extends from about the middle of the front vertical surfaces of the teeth to the gum line. The body 18 is formed so that it does not cover any bite surfaces of the subject's teeth, thereby allowing the bite surfaces of the top and bottom teeth to engage when the subject closes his or her jaw. Each appliance 12 is allegedly precision fabricated as a single piece by computer-controlled manufacturing using a 3D printer based upon a 3D scanned image of the subject's dentition.

U.S. Pat. No. 3,984,915 (to Noble, et al.) discusses magnets placed on the teeth in such a manner to employ the attraction and repulsion characteristics of a magnetic field. These forces are used to align teeth, tilt teeth, move root positions and angulations, torque teeth, and erupt impacted or partially impacted teeth into the correct position in the mouth. In the movement of a single tooth, normally a magnet will be attached to the single tooth with the other magnet which creates the repulsion or attraction force being attached to several teeth in combination. In FIG. 7 of Noble, a magnet is attached to a bridge supported by two spaced teeth. A third tooth, between the spaced teeth, is only partially erupted and a second magnet is attached thereto. An attractive force between the two magnets is said to encourage the further eruption of the third tooth. In addition to various arrangements for applying forces between teeth, Noble suggests a magnet-based retainer (FIG. 15) to hold teeth in position after they have been moved.

U.S. Patent Application Publication No. 2010/0183997 A1 by Darendeliler discusses a sequential orthodontic appliance comprising a body for engaging a plurality of teeth, and at least one magnetic attachment positioned so as to be in attractive or repulsive configuration with a magnet bonded to a surface of a tooth in need of repositioning. The body defines a space for allowing movement of the tooth in need of repositioning caused by attraction or repulsion. While a number of variations of the appliance are addressed (e.g., see 17, 22, 34, 39, 64, 84, 90, 100, 103, 187, 191, 203 and 208), very few construction details of physical characteristics are provided. However, the dotted outline of the appliances in the figures make it clear that the appliances cover the front of the teeth of the patient.

While these proposals, and others, have been made, it appears the proposals have deficiencies and have not been widely adapted. For instance, in the system of Hoyberg, the aligner tray and/or secondary magnet holder cover the front of the teeth and are esthetically unattractive. Additionally, it is not understood how the described appliances can be rigid enough to stop tooth movement as indicated at column 5, lines 30-36, and flexible enough to allow placement over teeth and magnets or magnetizable elements as illustrated, for example, in FIG. 6 of Hoyberg. The magnet-based aligner of Patel seems to suffer from similar issues, as do the devices of Ha and Darendeliler. Noble does not propose the use of an appliance for tooth movement other than the attachments of magnets to teeth and bridges. The retainer of Noble is suggested only as a means of holding teeth in position after they have been repositioned by other means.

### BRIEF DESCRIPTION

An orthodontic appliance system includes at least one first docking component configured to be attached to the lingual or palatal side of at least one respective support tooth, at least one target magnet, the at least one target magnet can be at least one of a magnet or a paramagnet. The at least one target magnet can be configured to be attached to at least one of the lingual, palatal, distal or mesial surface of at least one respective target tooth, at least one point on a bony palate and/or at least one point on a buccal bone. The orthodontic appliance system also includes a rigid support arch having respective at least one second docking component corresponding to, and for securement to, the at least one first docking component, the rigid support arch being configured to support at least one therapeutic magnet at at least one respective therapeutic position adjacent to a respective one of the at least one target magnet. At least one of the rigid support arches, at least one of the at least one target magnet or at least one of the at least one therapeutic magnet includes at least one stop configured to prevent or limit an aspect of movement of a tooth.

For example, the at least one first docking component can be at least one attachment magnet and the at least one second docking component can be at least one mounting magnet. In such embodiments, the at least one attachment magnet and the at least one mounting magnet can include at least one stop. Alternatively, in some embodiments the first and second docking components can include non-magnet and/or conventional orthodontic attachment mechanisms.

In one aspect of the presently described embodiments, an orthodontic appliance system comprises at least one first docking component configured to be attached to the lingual or palatal side of at least one respective support tooth; at least one target magnet, the at least one target magnet comprising at least one of a magnet or paramagnet, the at least one target magnet being configured to be attached to at least one of a lingual, palatal, distal or mesial surface of at least one respective target tooth, at least one point on a bony palate and/or at least one point on a buccal bone; a rigid support arch having respective at least one second docking component corresponding to, and for securement to, the at least one first docking component, the rigid support arch being configured to support at least one therapeutic magnet at least at one respective therapeutic position adjacent a respective one of the at least one target magnet; wherein the at least one of the rigid support arch, at least one of the at least one target magnet or at least one of the at least one therapeutic magnet includes at least one stop configured to prevent or limit an aspect of movement of a tooth.

In another aspect of the presently described embodiments, the rigid support arch comprises an orthodontic wire.

In another aspect of the presently described embodiments, the rigid support arch comprises a metal band.

In another aspect of the presently described embodiments, the rigid support arch comprises a thermoplastic appliance.

In another aspect of the presently described embodiments, the rigid support arch comprises a resin-based appliance.

In another aspect of the presently described embodiments, the rigid support arch comprises a rigid thermoplastic or resin.

In another aspect of the presently described embodiments, at least one of the at least one target or at least one of the at least one therapeutic magnet has a non-planar shape.

In another aspect of the presently described embodiments, the non-planar shape comprises an L-shape.

In another aspect of the presently described embodiments, the L-shape comprises an obtuse angle between legs of the L-shape.

In another aspect of the presently described embodiments, the non-planar shape comprises one of a C-shape and a U-shape in cross section from an occlusal view.

In another aspect of the presently described embodiments, at least one target of the at least one target comprises an extended target that is larger in at least one dimension than a corresponding dimension of an exposed portion the at least one associated target tooth.

In another aspect of the presently described embodiments, the at least one stop comprises a first stop and a second stop, the first stop being configured to make an initial contact during a therapeutic movement of a tooth, thereby limiting a first aspect of the therapeutic movement the tooth, while the second stop has not yet made a contact, thereby allowing a second aspect of therapeutic movement of the tooth.

In another aspect of the presently described embodiments, the rigid support arch includes at least one extension configured to extend into a space left by an extracted or missing tooth and the at least one therapeutic magnet includes at least one therapeutic magnet mounted on the at least one extension and the at least one target magnet includes at least one target magnet mounted on at least one mesial or distal surface of at least one target tooth adjacent the space left by the extracted or missing tooth.

In another aspect of the presently described embodiments, the at least one extension that is configured to occupy the space left by an extracted or missing tooth comprises a tooth shaped pontic.

In another aspect of the presently described embodiments, the rigid support arch supports at least one non-magnetic guide plane configured to provide a supplemental contact-based guidance to urge a tooth in a desired direction.

In another aspect of the presently described embodiments, the rigid support arch wherein at least one of the at least one target magnet and at least one of the at least one therapeutic magnet are configured to have opposite poles facing each other while at least one of the at least one target magnet and the at least one therapeutic magnet include at least one stop configured to prevent movement of the target tooth toward the therapeutic magnet.

In another aspect of the presently described embodiments, the L-Shaped magnet is configured to urge the target tooth occlusally, lingually and/or laterally.

In another aspect of the presently described embodiments, at least one of the at least one target magnet and the at least one therapeutic magnet supports at least a first stop and a second stop, the first stop being configured to contact the other of the at least one target magnet and the at least one therapeutic magnet during a therapeutic time period before the second stop contacts the other of the at least one target magnet and the at least one therapeutic magnet, thereby providing a pivot point for achieving a desired movement of an associated target tooth.

In another aspect of the presently described embodiments, the at least one target magnet and the at least one therapeutic magnet comprise complementary triangular shapes whereby respective hypotenuses of the triangular shapes can be configured to face each other.

In another aspect of the presently described embodiments, the at least on target magnet comprises a first target magnet and a second target magnet configured to be attached to a lingual or palatal side of a same respective target tooth and wherein the rigid support arch is configured to support a first therapeutic magnet and a second therapeutic magnet adjacent the same respective target tooth, wherein the first target magnet and the first therapeutic magnet are configured to produce an attractive force therebetween and the second target magnet and the second therapeutic magnet are configured to produce a repulsive force therebetween.

In another aspect of the presently described embodiments, at least one of the at least one therapeutic magnet is configured to include a substantially horizontal lever arm longer than the width of an associated target tooth.

In another aspect of the presently described embodiments, the substantially horizontal lever arm supports a magnetic attachment at a distal end thereof.

In another aspect of the presently described embodiments, the rigid support arch includes at least one occlusal extension configured to apply intruding forces to at least one tooth.

In another aspect of the presently described embodiments, the rigid support arch includes at least one sagittal stabilization stop configured to contact a rear surface of a respective at least one attachment magnet and limit forward movement of the rigid support arch.

In another aspect of the presently described embodiments, the at least one first and the at least one second docking components comprise respective at least one attachment and at least one mounting magnet.

In another aspect of the presently described embodiments, the at least one first docking component comprises at least one set of conjoined attachment magnets.

In another aspect of the presently described embodiments, at least one of the at least one mounting magnet includes a horizontal extension configured to extend from the at least one mounting magnet to an area adjacent a second face of a respective attachment magnet.

In another aspect of the presently described embodiments, the horizontal extension includes at least one stop on the horizontal extension configured to prevent vertical movement of an associated support tooth due to attractive magnetic force between the at least one mounting magnet including the horizontal extension and the attachment magnet.

In another aspect of the presently described embodiments, at least one of the at least one therapeutic magnet includes a horizontal extension configured to extend from the at least one therapeutic magnet to an area adjacent to and approximating a second face of a respective target magnet.

In another aspect of the presently described embodiments, the horizontal extension includes a first stop and a second stop on a surface of the horizonal extension approximating the second face of the target magnet, wherein the first stop is configured to be positioned at a point that is closer to the top surface of the target magnet that the second stop, thereby limiting vertical movement of the corresponding side of the target magnet relative to a side of the target magnet corresponding to a location of the second stop.

In another aspect of the presently described embodiments, the rigid support arch comprises at least one of orthodontic rod, orthodontic wire, injection molded plastic, cast plastic and 3D printed material including ferromagnetic material.

In another aspect of the presently described embodiments, the orthodontic appliance system comprises a transpalatal arch connecting one or more attachment magnets from either side of the rigid support arch.

In another aspect of the presently described embodiments, the rigid support arch is configured to follow the contour of a palate of a patient.

In another aspect of the presently described embodiments, at least one of the at least one target is configured to be mounted on an implant configured to be implanted in the bony palate.

In another aspect of the presently described embodiments, the rigid support arch comprises occlusal extensions configured to cover and transmit therapeutic force between the at least one target magnet and at least one therapeutic magnet to at least one target tooth.

In another aspect of the presently described embodiments, at least one of the at least one target magnet is configured to be mounted on an implant configured to be implanted in the buccal bone.

In another aspect of the presently described embodiments, the rigid support arch is configured to support a horizontal extension, the horizontal extension being configured to contact an occlusal surface between teeth.

In another aspect of the presently described embodiments, the rigid support arch is configured to support a distal extension, the distal extension being configured to contact an occlusal surface of one of the at least one respective support tooth and further extend as a buccal extension to embrace a buccal surface of the one of the at least one respective support tooth and support a stabilizing magnet at a position adjacent to at least one stabilizing implant magnet mounted on a stabilizing implant implanted in the buccal bone.

In another aspect of the presently described embodiments, at least one therapeutic magnet is L-shaped and one leg of the L-shaped magnet comprises a horizontal extension of the at least one therapeutic magnet the horizontal extension comprising a stop configured to initially be spaced from a mesial surface of one of the at least one target magnet and to be contacted by the mesial surface of the one of the at least one target magnet only after a therapeutic mesial movement of the target tooth associated with the one of the at least one target magnet.

In another aspect of the presently described embodiments, at least one mounting magnet is L-shaped and one leg of the L-shaped magnet comprises a horizontal extension of the at least one therapeutic magnet the horizontal extension comprising a stop configured to initially contact a mesial surface of one of the at least one attachment magnet thereby preventing mesial movement of the support tooth associated with the one of the at least one attachment magnet.

In another aspect of the presently described embodiments, the rigid support arch comprises a horizontal extension configured to reach through a space between teeth to support at least one stabilizing implant magnet at a stabilizing position corresponding to a stabilizing implant magnet configured to be mounted on an implant implanted in a buccal bone.

In another aspect of the presently described embodiments, the horizontal extension is configured to abut a surface of a tooth, thereby providing further stabilization.

In another aspect of the presently described embodiments, at least one of the at least one attachment magnet includes a seat configured to receive a guide key extending from an associated mounting magnet.

In another aspect of the presently described embodiments, at least one of the at least one mounting magnet includes a guide key configured to be received in a seat included in an associated attachment magnet.

In another aspect of the presently described embodiments, the rigid support arch comprises at least one of a permanent magnet in the form of an arch shaped strip and an arch shaped strip including isolated magnetized regions.

In another aspect of the presently described embodiments, at least one of the at least one therapeutic magnet comprises a therapeutic magnet extension configured to face a mesial side or a distal side of at least one of the at least one target magnet.

In another aspect of the presently described embodiments, at least one of the at least one mounting magnet is L-shaped due to inclusion of a horizontal mounting extension configured to provide a mesio-distal support force.

In another aspect of the presently described embodiments, the horizontal mounting extension includes at least one stop for opposing mesio-distal movement of at least one associated support tooth.

In another aspect of the presently described embodiments, the rigid support arch is configured to be located gingival to the crowns of teeth of an associated patient and wherein the at least one mounting magnet and the at least one therapeutic magnet are attached to the rigid support arch by vertical extensions from the rigid support arch.

In another aspect of the presently described embodiments, the rigid support arch, at least one mounting magnet and the at least one therapeutic magnet are a single unitary manufacture.

In another aspect of the presently described embodiments, the rigid support arch comprises an upper rigid support arch and the at least one mounting magnet comprises at least one upper mounting magnet, at least one of the at least one upper mounting magnet comprising a downward extension, the orthodontic appliance system further comprising a lower rigid support arch having at least one lower mounting magnet, at least one of the at least one lower mounting magnet comprising an upward extension wherein extensions of respective at least one pair of the downward extension of the at least one upper mounting magnet and the upward extension of the at least one lower mounting magnet are configured to magnetically attract one another when installed in an associated patient, thereby urging an upper dental arch and a lower dental arch of the associated patient toward one another in an antero-posterior direction.

In another aspect of the presently described embodiments, at least one of the at least one attachment magnet and at least one mounting magnet comprise a stop.

In another aspect of the presently described embodiments, the rigid support arch and at least one of the at least one therapeutic magnet and at least one mounting magnet comprise at least one set of interlocking portions.

In another aspect of the presently described embodiments, the interlocking portions comprise at least one half-blind dovetail in the rigid support arch and a dovetail pin in the at least one of the at least one therapeutic magnet and at least one mounting magnet.

In another aspect of the presently described embodiments, at least one of the attachment magnets on either side of the rigid support arch and connected by the transpalatal arch is a wide attachment magnet configured to be attached to two or more support teeth.

In another aspect of the presently described embodiments, the at least one of the at least one attachment magnet includes at least one a spring clip configured to participate in retaining the guide key in the seat.

In another aspect of the presently described embodiments, the at least one of the at least one attachment magnet includes a door that is configured to be securable under the at least one spring clip and over the seat, thereby being configured to participate in retaining the guide key in the seat.

In another aspect of the presently described embodiments, the at least one spring clip comprises two spring clips configured to be installed on either side of the seat and wherein the guide key includes a stabilization member including a first arm and a second arm that extend out in two opposite directions perpendicular to a top surface of a distal end of the guide key, thereby forming a T-shape, the stabilization member being configured to rest on a top surface of the attachment magnet when the guide key is in the seat, and wherein the spring clips are configured to capture the first arm and the second arm of the stabilization member respectively.

In another aspect of the presently described embodiments, at least one of the at least one therapeutic magnet includes a slot or pocket configured to accept one or more additional magnets.

In another aspect of the presently described embodiments, the orthodontic appliance system comprises at least one additional magnet.

In another aspect of the presently described embodiments, at least one of the at least one target magnet comprises the L-shape with an angle between a shorter leg and a longer leg of the L-shape wherein the shorter leg is configured to be bonded to and extend briefly lingually away from the crown of an associated target tooth of an associated patient and the longer leg is configured to extend, at an angle, away from the shorter leg, approximating a local contour of a bony palate of the associated patient until a distal end of the longer leg reaches a bit beyond a vertical location of a center of resistance in a root of the target tooth; and wherein the rigid support arch is configured to support a therapeutic magnet corresponding to and for magnetic attraction to the target magnet at the distal end of the longer leg of the target magnet at a point centered on and horizontally aligned in line with the center of resistance of the associated target tooth, whereby a force formed due the magnetic interaction between the therapeutic magnet and target magnet would act in a direction horizontally through the center of resistance.

In another aspect of the presently described embodiments, the rigid support arch includes an extension configured to grasp a front edge of the crown of the associated target tooth.

In another aspect of the presently described embodiments, the orthodontic appliance system further comprises at least one of a first and/or second additional magnet and an L-shaped extension of the rigid support arch, wherein the first additional magnet is configured to be mounted on the distal end of the long leg of the target magnet, the second additional magnet being configured to be mounted on the short leg of the target magnet, the L-shaped extension of the rigid support arch having a longer leg extending from the rigid support arch generally parallel to the long leg of the target magnet and a short leg extending from a distal end of the long leg generally parallel to the short leg of the target magnet, the short leg of the extension of the rigid support arch supporting an auxiliary therapeutic magnet.

In another aspect of the presently described embodiments, at least one of the at least one target comprises the L-shape with an angle between a shorter leg and a longer leg of the L-shape wherein the shorter leg is configured to be bonded to and extend briefly lingually away from the crown of an associated target tooth of an associated patient and wherein the longer leg is configured to extend, at an angle, away from the shorter leg and approximating a local contour of a bony palate of the associated patient until a distal end of the longer leg reaches beyond a vertical location of a center of resistance in a root of the target tooth; and wherein the rigid support arch is configured to support a therapeutic magnet corresponding to and for magnetic attraction to the target magnet at the distal end of the longer leg of the target magnet centered on and aligned horizontally in line with a point beyond the center of resistance, closer to root end of the target tooth, whereby a force formed due the magnetic interaction between the therapeutic magnet and target magnet would act in a direction horizontally through the center of resistance.

In another aspect of the presently described embodiments, the rigid support arch is configured to change the position of teeth and has extensions which hold labial veneers which are connected to each other thereby mimicking the final position of the teeth.

In another aspect of the presently described embodiments, a method for performing an orthodontic procedure comprises using the orthodontic appliance system as described herein.

### BRIEF DESCRIPTION OF THE DRAWINGS

FIGS. 1A-C illustrate a first embodiment of a rigid support arch and other components of a magnet-based orthodontic appliance system.

FIGS. 2A-C illustrate a second embodiment of a rigid support arch and other components of a magnet-based orthodontic appliance system.

FIGS. 3A-C illustrate a third embodiment of a rigid support arch and other components of a magnet-based orthodontic appliance system.

FIGS. 4A-C illustrate a fourth embodiment of a rigid support arch and other components of a magnet-based orthodontic appliance system. The rigid support arch includes tooth shaped pontics.

FIGS. 5A-C illustrate a fifth embodiment of a rigid support arch and other components of a magnet-based orthodontic appliance system.

FIGS. 6A-C illustrate a sixth embodiment of a rigid support arch and other components of a magnet-based orthodontic appliance system. The illustrated embodiment includes non-planar magnets.

FIGS. 7A-C illustrate a seventh embodiment of a rigid support arch and other components of a magnet-based orthodontic appliance system.

FIGS. 8A-C illustrate an eighth embodiment of a rigid support arch and other components of a magnet-based orthodontic appliance system. The illustrated embodiment includes non-planar magnets.

FIG. 9A-C illustrate a ninth embodiment of a rigid support arch and other components of a magnet-based orthodontic appliance system. The embodiment illustrates examples of target magnets attached to implants.

FIGS. 10A-C illustrate a tenth embodiment of a rigid support arch and other components of a magnet-based orthodontic appliance system. The embodiment illustrates an example of a rigid support arch with sagittal stabilization arms.

FIGS. 11A-B illustrate an eleventh embodiment of a rigid support arch and other components of a magnet-based orthodontic appliance system. The embodiment illustrates an example of a trans-palatal arch.

FIGS. 12A-D illustrate a twelfth embodiment of a rigid support arch and other components of a magnet-based orthodontic appliance system.

FIGS. 13A-D illustrate a thirteenth embodiment of a rigid support arch and other components of a magnet-based orthodontic appliance system. The embodiment illustrates examples of stabilization magnets attached to arch extensions adjacent to stabilization implant magnets attached to implants and used for arch stabilization.

FIGS. 14A-C illustrate a fourteenth embodiment of a rigid support arch and other components of a magnet-based orthodontic appliance system.

FIGS. 15A-C illustrate a fifteenth embodiment of a rigid support arch and other components of a magnet-based orthodontic appliance system.

FIGS. 16A-C illustrate a sixteenth embodiment of a rigid support arch and other components of a magnet-based orthodontic appliance system.

FIGS. 17A-C illustrate a seventeenth embodiment of a rigid support arch and other components of a magnet-based orthodontic appliance system. The embodiment illustrates an example of a rigid support arch configured to be situated apical to the level of the crown of the teeth.

FIGS. 18A-C illustrate an eighteenth embodiment of a magnet-based orthodontic appliance system. The illustrated embodiment includes and upper and a lower rigid support arch.

FIGS. 19A-B illustrate aspects of an embodiment of a magnet and aspects of a compatible embodiment of a rigid support arch.

FIGS. 20A-C illustrate aspects of an embodiment of an attachment magnet including a slot or seat and a mounting magnet including a guide key for reception in the slot or seat.

FIGS. 21A-B illustrate aspects of an embodiment of an attachment magnet including a slot or seat and a mounting magnet including a guide key for reception in the slot or seat.

FIG. 22 illustrates aspect of an embodiment a magnet base orthodontic appliance system including an embodiment of a target magnet and an embodiment of a modifiable therapeutic magnet.

FIG. 23 illustrates a cross-sectional view of an embodiment of a target magnet mounted to a palatal or lingual side of a tooth and an embodiment of a rigid support arch supporting an embodiment of a therapeutic magnet behind the tooth.

FIG. 24 illustrates a cross-sectional view of an embodiment of an L-shaped target magnet mounted to a palatal or lingual side of a tooth and an embodiment of a rigid support arch supporting an embodiment of a therapeutic magnet behind the tooth for providing a force in a line through a center of resistance of the tooth.

FIG. 25 illustrates a cross-sectional view of an embodiment of an L-shaped target magnet mounted to a palatal or lingual side of a tooth and an embodiment of a rigid support arch supporting an embodiment of a therapeutic magnet behind the tooth for providing a force in a line through a point closer to a root end of the tooth, apical to the center of resistance of the tooth.

FIG. 26 illustrates a cross-sectional view of an embodiment of an L-shaped target magnet mounted to a palatal or lingual side of a tooth and an embodiment of a rigid support arch supporting an embodiment of a therapeutic magnet behind the tooth for providing a force in a line through a point closer to a root end of the tooth, apical to the center of resistance of the tooth wherein the rigid support arch includes an extension to restrict outward movement of an incisal edge of the tooth.

FIG. 27 illustrates a cross-sectional view of an embodiment of an L-shaped target magnet mounted to a palatal or lingual side of a tooth and an embodiment of a rigid support arch supporting an embodiment of a therapeutic magnet behind the tooth for providing a force in a line through a point closer to a root end of the tooth, apical to the center of resistance of the tooth wherein the rigid support arch includes an extension to support an additional therapeutic magnet at a second position to obtain the desired force vector.

FIGS. 28A-C illustrate an embodiment of a rigid support arch and other components of a magnet-based orthodontic appliance system including only a single attachment magnet and only a single mounting magnet.

FIGS. 29A-D illustrate another embodiment of a magnet based orthodontic appliance.

FIG. 30 illustrates another embodiment of a magnet based orthodontic appliance with veneers attached.

FIGS. 31A-B illustrate components of magnet based orthodontic appliance which are attached to the teeth.

### DETAILED DESCRIPTION

In order to overcome the above-mentioned shortcomings, a hidden removable magnet-based appliance system is proposed, wherein the appliance will not flex significantly in response to the magnetic forces involved and wherein, when desired, the appliance is easily removed and installed by the patient. Easy patient installation and removal has important health consequences as it means the appliance is less likely to interfere with eating and makes it much easier to floss and brush the teeth of the patient. Still further, easy installation and removal makes it much easier to maintain the hygiene of the appliance. A rigid appliance prevents the reduction of the force delivered due to the flexion of the appliance while magnetic forces are being used to move teeth. While ease of removal is preferable, in some scenarios, patients are not likely to be compliant and if able, might not reinstall an appliance as promptly after eating or cleaning as they should. Accordingly, some embodiments allow scenarios wherein the appliance is installed in a manner that would be more difficult for the patient to remove on his or her own.

The present disclosure may be understood more readily by reference to the following detailed description of desired embodiments and the examples included therein. In the following specification and the claims which follow, reference will be made to a number of terms which shall be defined to have the following meanings.

Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

The singular forms “a,” “an,” and “the” include plural referents unless the context clearly dictates otherwise.

The term “comprising” is used herein as requiring the presence of the named components/steps and allowing the presence of other components/steps. The term “comprising” should be construed to include the term “consisting of”, which allows the presence of only the named components/steps.

Numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 grams to 10 grams” is inclusive of the endpoints, 2 grams and 10 grams, and all the intermediate values). The endpoints of the ranges and any values disclosed herein are not limited to the precise range or value; they are sufficiently imprecise to include values approximating these ranges and/or values.

The modifier “about” used in connection with a quantity is inclusive of the stated value and has the meaning dictated by the context. When used in the context of a range, the modifier “about” should also be considered as disclosing the range defined by the absolute values of the two endpoints. For example, the range of “from about 2 to about 10” also discloses the range “from 2 to 10.” The term “about” may refer to plus or minus 10% of the indicated number. For example, “about 10%” may indicate a range of 9% to 11%, and “about 1” may mean from 0.9-1.1.

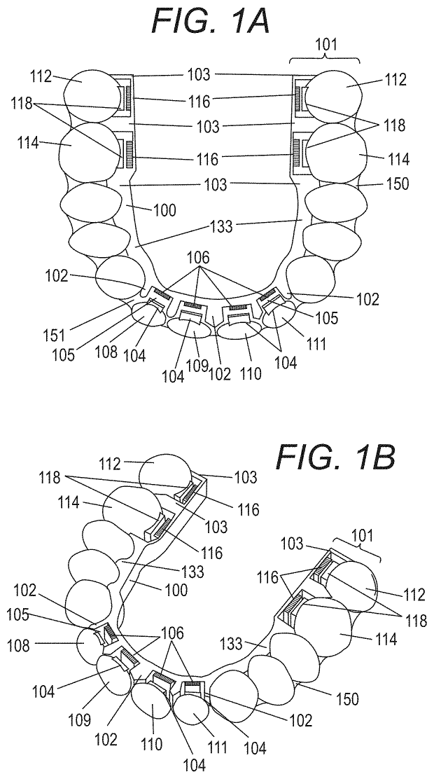

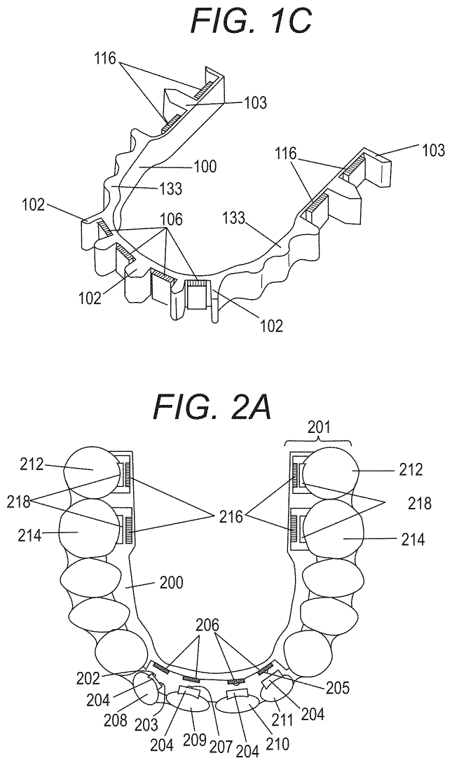

In an embodiment illustrated in FIGS. 1A-C, a magnet-based orthodontic appliance system 101 includes at least one first docking component such as at least one attachment magnet 118 configured to be attached to the lingual or palatal side of at least one respective support tooth (e.g., 112, 114). For instance, four support teeth 112 and 114 might be used. The magnet based orthodontic appliance system 101 includes a rigid support arch 100 having respective at least one second docking component such as at least one mounting magnet 116. The appliance system can include stops. For example, the support arch 100 includes one or more stops in the form of stop arch extensions 103. The rigid support arch 100 is secured in position by the docking components, for example, by attractive magnetic forces between the mounting magnets 116 and attachment magnets 118. Though there is an attractive force between the mounting magnets 116 and attachment magnets 118, which might otherwise be carried through to the support teeth 112, 114, the support teeth 112, 114 are protected from those forces and are prevented from significant movement toward the rigid support arch 100 by stops (e.g., 103), which oppose the attractive force by physically preventing tooth movement. In the illustrated embodiment, stops or arch extensions 103 are configured to contact the lingual or palatal side of the support teeth 112, 114 and maintain a separation between the first docking component(s), in this case attachment magnets 118 and the second docking component(s), in this case the mounting magnets 116. The rigid support arch 100 is configured to be held in place by magnetic forces between the attachment magnets 118 and mounting magnets 116. Stop arch extensions 103 prevent direct contact of the approximating surfaces. Close approximation 133 of the rigid support arch 100 to the palatal or lingual surface of other teeth of the illustrated set of teeth 150 can be used to provide a guide for the fit of the appliance in the mouth when the patient is inserting it.

The rigid support arch 100 supports at least one therapeutic magnet 106 at therapeutic positions corresponding to at least one target magnet 104 attached to the palatal or lingual side of at least one target tooth 108-111. For instance, in the illustrated scenario, four target teeth 108-111 are mispositioned. For example, the teeth 108-111 have gaps or undesired space on either side. Respective pairs of the therapeutic magnets 108 and target magnets 104 would provide respective magnetic forces for urging (e.g. pulling) the target teeth 108-111 toward a preferred position. The appliance system 101 includes further stops in the form stop arch extensions 102 which extend from the rigid support arch 100 toward the target teeth 108-111. Initially the stops (extensions 102) do not make contact with the target teeth 108-111. The attractive force between the therapeutic magnets 106 and target magnets 104 pulls the target teeth 108-111 toward the rigid support arch 100 in order to urge the target teeth backward and reduce the size of the gaps or spaces between the target teeth and the teeth adjacent thereto. A space 105 between the therapeutic magnets 106 and the target magnets 104 is more than a space 151 between the extensions 102 from the support arch 100 and the palatal or lingual side of the target teeth 108-111. Accordingly, as the teeth are pulled back toward the desired position by the therapeutic forces between the therapeutic magnets 106 and the target magnets 104, the stops or extensions 102 would prevent direct contact between the therapeutic magnets 106 and the target magnets 104 and prevent the target teeth from being repositioned back further than desired. While direct contact may, in some scenarios be necessary or desirable, direct contact between the magnets on the teeth and those on the support arch would makes it difficult for the patient to insert and remove the appliance due to, for example, the very strong magnetic forces produced under those circumstances. Accordingly, another reason this embodiment includes the stops or extensions 102 is to prevent such direct approximation.

It is noted that while the word “magnet” is used herein throughout for clarity, it is to be understood that as used herein, the word “magnet” does not necessarily refer to a permanent magnet. In some embodiments or scenarios, it may be acceptable or beneficial for only one magnet of a magnet pair (e.g., a therapeutic and target magnet or an attachment and mounting magnet) to be a permanent magnet. The other magnet of a magnet pair may be a paramagnet or element made of material that becomes magnetized in the presence of a magnetic field. For example, one element of a pair might be made of stainless steel or other ferromagnetic material that becomes magnetized and drawn to its mate in the presence of the magnetic field from that mate. For simplicity and clarity, it is to be understood that in any description where attractive magnetic forces are discussed or implied, one of the magnets of the pair may be a paramagnetic element. In applications where repulsive forces are employed, both magnets must be permanent magnets so that like magnetic poles of the pair can be configured to face one another, thereby providing the repulsive force. Biocompatibility can be achieved by making the magnets of a bio-compatible material or by coating or encapsulating the magnets in a bio-compatible material. For example, the bio-compatible material that could be used to coat the magnet could be a varnish, plastic, gold, silver, steel, metal alloy, or other appropriate metal or metal alloy. In addition, a coating such as a gold coating could then be coated with a second coating such as steel or other appropriate bio-compatible material. The second coating such as steel could serve multiple purposes such as protecting the underlying coating and of enhancing the magnetic forces.

It should also be appreciated that the respective magnets for teeth may be attached to or incorporated into the teeth in a variety of manners including, for example, with use of cement or adhesives. Likewise, the respective magnets for the appliance may be unitary with the appliance (e.g., by stamping, casting, or additive manufacturing) or attached using any of a variety of manners including, for example, using screws, brackets, cement, adhesives, etc.

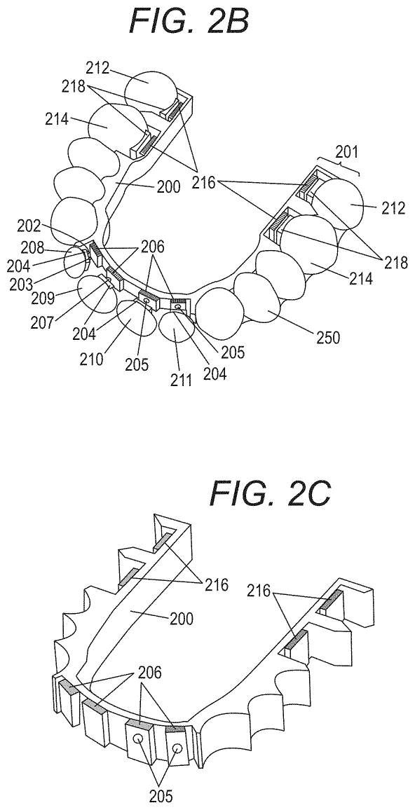

FIGS. 2A-C illustrate a magnet-based orthodontic appliance system 201 relative to a set of teeth 250. The magnet-based appliance system 201 includes at least one first docking component such as attachment magnets 218 configured to be attached to the lingual or palatal side of at least one respective support tooth 212, 214. In the illustrated embodiment, four support teeth 212, 214 are used. The magnet-based orthodontic appliance system 201 includes a rigid support arch 200 having respective at least one second docking component such as mounting magnet 216 corresponding to and for magnetic attraction to at least one attachment magnet 218. The support arch 200 is secured in position by the attractive magnetic forces between the mounting magnets 216 and attachment magnets 218.

The rigid support arch 200 supports at least one therapeutic magnet 206 at therapeutic positions corresponding to target magnets 204 attached to the palatal or lingual side of the four target teeth 208-211. As with the target teeth 108-111 in FIGS. 1A-C, target teeth 208-211 are associated with gaps or spaces on either side. Additionally, tooth 208 is initially rotated out of proper alignment. Attractive forces between the therapeutic magnets 206 and target magnets 204 urge the target teeth 208-211 toward the rigid support arch 200. As noted above, the rigid support arch is held in place by the magnetic interaction between the mounting magnets 216 on the support arch 200 and the attachments magnets 218 on the support teeth 212, 214. The appliance system 201 includes stops. For instance, the therapeutic magnets 206 and target magnets 204 have one or more extensions or protrusions which form stops 202, 203, 205, 207. The stops 202, 203, 205, 207 prevent a direct approximation of therapeutic magnets 206 and target magnets 204 as the target teeth 208-211 are urged towards the support arch 200. In the illustrated embodiment, the stops 202 and 203 are present on the target magnet 204 on the target tooth 208, stop 207 is present on the target magnet 204 on the target tooth 209, and one stop 205 each are illustrated on the therapeutic magnets 206 present in positions corresponding to the target magnets 204 on the target teeth 210 and 211. In the case of the tooth 208, it is anticipated that the stop 202 on the target magnet 204 would make an initial contact with the therapeutic magnet 206 preventing further retraction on the distal side of the tooth while the mesial side would continue retraction until the stop 203 on the target magnet 204 contacted the therapeutic magnet 206. This differential movement would provide a de-rotation and alignment of the tooth 208 during the planned retraction.

Stops on magnets might be made unitary with the magnet. For instance, a cast, molded, machined, or additively manufactured (e.g., 3D printed) magnet might be made as a single piece including one or more protrusions to act as stops, such as those discussed above (e.g., 202-207). While such embodiments might lead to direct approximation of one magnet to another at the point of the stop, the small surface area of direct approximation or contact between the magnets would limit the force between the magnets relative to the force that might otherwise occur if the full faces of the magnets came in contact. Accordingly, even embodiments wherein the stops are unitary with the magnets would improve the ease with which the rigid support arch can be removed. In other embodiments, the stops of non-magnetic material (e.g., plastic or rubber) might be adhesively attached or molded into the magnet or the magnet might be threaded and stops might be screwed into the magnet. It is noted that the rigid support arch 200 also includes stop arch extensions (unnumbered) that are similar to the stop arch extensions 103 of FIGS. 1A-C.

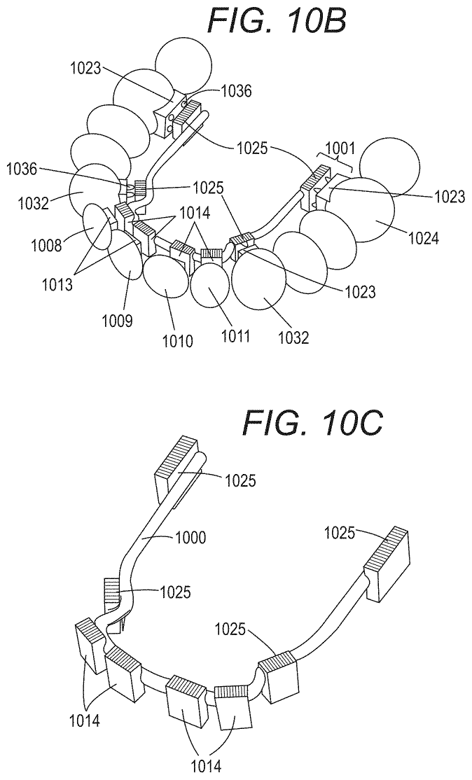

As implied above, stops on rigid support arches might also be unitary with the arch. For example, a cast, molded, machined, or additively manufactured rigid support arch might be made as a single piece including one or more extensions to act as stops, such as those discussed above (e.g., 102, 103). In some embodiments the target and/or mounting magnets might also be unitary with the rigid support arch. For example, a rigid support arch might be cast, molded, machined, or additively manufactured from a ferromagnetic material or from plastics or epoxies with ferromagnetic suspensions. Alternatively, embodiments might be assembled from component parts that are screwed, glued, welded, soldered, and/or snapped or mated together. Some embodiments, such as plastic or epoxy-based embodiments, might be reinforced with orthodontic wire or metal strips or rods for added rigidity. Rod or wire with a diameter of about 0.045 to about 0.06 inches or more may be appropriate. In some applications, thinner material may suffice. In some embodiments (e.g., see FIGS. 10-15) the rigid support arch might be substantially made of orthodontic wire or metal rod.

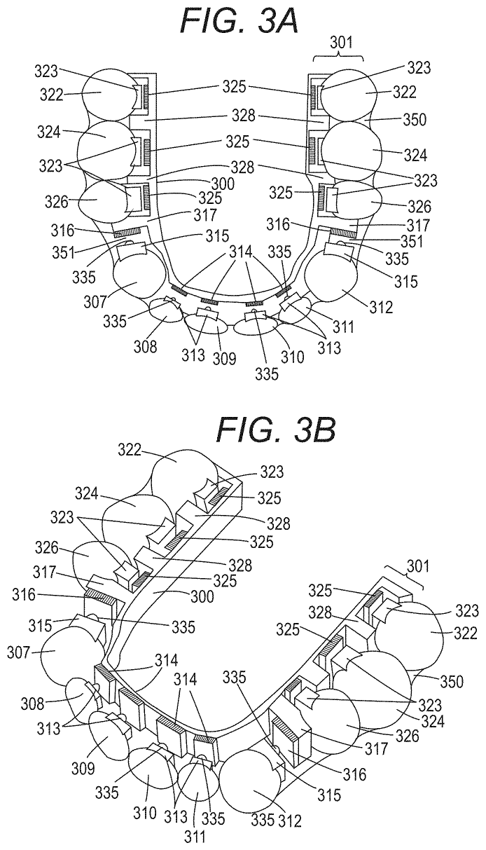

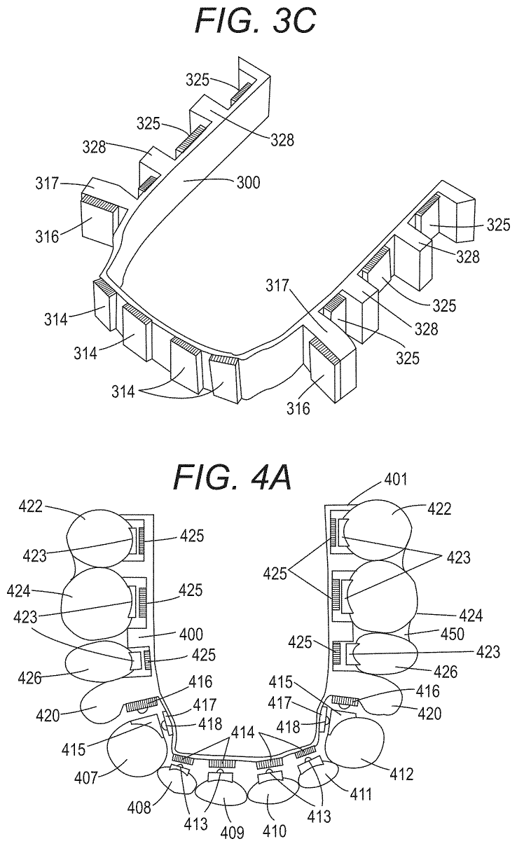

In the embodiment illustrated in FIGS. 3A-C, a magnet-based orthodontic appliance system 301 includes at least one first docking component such as, for example, at least one attachment magnet 323 configured to be attached to the lingual or palatal side of at least one respective support tooth 322, 324 and 326 of a set of teeth 350. In the illustrated embodiment, six support teeth 322, 324 and 326 are used. The magnet based orthodontic appliance system 301 includes a rigid support arch 300 having respective at least one second docking element such as, for example, mounting magnets 325 corresponding to and for magnetic attraction to attachment magnets 323. The support arch 300 is secured in position by attractive magnetic forces between the mounting magnets 325 and attachment magnets 323. The stops or extensions 328 are configured to contact the lingual or palatal surface of the support teeth 322, 324 and 326 and act as guides for positioning of the support arch in the mouth by the patient. Additionally, the stops, guides or extensions 328 prevent movement of the support teeth 322, 324 and 326 which might otherwise occur due to the attractive magnetic forces between the mounting magnets 325 and the attachment magnets 323 by physically opposing the magnetic force by contacting, for example, the support teeth 322, 324, 326.

The rigid support arch 300 supports at least one therapeutic magnet 314 at at least one therapeutic position corresponding to at least one target magnet 313 attached to the palatal or lingual side of at least one target tooth 308-311. The support arch 300 also has at least one therapeutic magnet 316 attached to arms or extensions 317 which project into extraction space 351 in front of teeth 326. The therapeutic magnets 316 are mounted at the therapeutic positions corresponding to target magnets 315 attached on respective distal surfaces of the target teeth 307 and 312. Stops or small projections 335 are provided on the target magnets 313 and 315. Attractive forces between the therapeutic magnets 314 and 316 and the respective target magnets 313 and 315 urges (e.g., pulls) the target teeth 307-312 backward toward the rigid support arch 300. The stops 335 on the target magnets 313 and 315 prevent a flush contact or approximation between the target magnets 313 and 315 with the respective therapeutic magnets 314 and 316 as the teeth 307-312 move backward towards the rigid support arch 300 and/or the arms or extensions 317 thereof. While the target magnet 315 is on a distal surface of the tooth 307 in the illustrated embodiment, other configurations are contemplated. For example, a target magnet could instead be placed on a mesial surface of, for example, tooth 326 and a rigid support arch could be configured to support a therapeutic magnet so as to urge (e.g. pull) the tooth 326 forward.

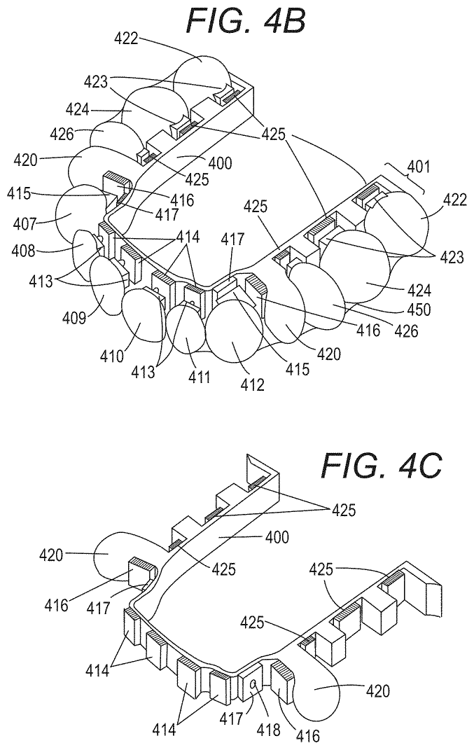

FIGS. 4A-C illustrate an embodiment of a magnet based orthodontic appliance system 401 that might be used, for example, for retraction of six anterior teeth 407-412 into a space in front of teeth 426. The system 401 includes a rigid support arch 400 that is secured in position by the attractive magnetic forces between at least one mounting magnet 425 and at least one attachment magnet 423 bonded to the palatal or lingual side of the one or more support teeth 422, 424 and 426 of a set of teeth 450. First and second docking components comprise the attachment magnets 423 and mounting magnets 425. The rigid support arch 400 includes tooth shaped extensions which form pontics 420 configured to be located in spaces or gaps in the set of teeth 450 located in front of the teeth 426. The rigid support arch also supports guide planes 417 for guiding movement of target teeth 407 and 412. It is noted that the rigid support arch 400 also includes stop arch extensions (unnumbered) that are similar to the stop arch extensions 103 of FIGS. 1A-C.

The rigid support arch 400 supports at least one therapeutic magnet 414 at at least one therapeutic position corresponding to at least one target magnet 413 attached to the palatal or lingual side of target teeth 408-411. As indicated above, the support arch 400 also supports at least one therapeutic magnet 416, attached to extensions 420 which project from the support arch 400 into extraction spaces in front of the teeth 426. For instance, the illustrated therapeutic magnets 416 are mounted at therapeutic positions corresponding to the target magnets 415 attached to target the teeth 407 and 412. The extensions 420 from the support arch 400 are configured to resemble natural teeth. For example, the extensions 420 are also configured to occupy most of the extraction space seen in front of teeth 426 except for the space needed for the retraction of the teeth 407 and 412 during several stages of tooth movement. At subsequent stages, the appliance system 401 would be replaced or modified to continue retraction of the teeth 407-412. In each subsequent replacement appliance system 401, the width of the extension 420 would be reduced. The reduction in the width of extensions or pontics 420 would be in response to a reduction in the size of the space or gap due to a rearward movement of the associated target teeth 407 and 412 and would allow the one or more therapeutic magnets 416 to be moved further back, closer to the teeth 426 allowing movement of the teeth 407 and 412 backward.

As indicated above, the rigid support arch 400 also supports one or more non-magnetic guide planes 417 in a position corresponding to the surface of one or more target magnets that face the support arch 400. The one or more non-magnetic guide planes 417 would provide a supplemental contact-based force to urge a tooth in a desired direction. For example, as therapeutic magnets 416 urge target teeth 407 and 412 reward, guide planes prevent the target teeth 407, 412 from straying inward and may even be configured to, at least initially, provide on outward force vector. That is, if the target teeth 407, 412 wander inward toward the rigid support arch 400, the target teeth 407, 412, or magnets 415 thereon, would contact the non-magnetic guide planes 417 and through that contact be urged (e.g., pushed) outward toward the desired path. The one or more non-magnetic guide planes might carry one or more stops 418 in order to reduce the friction which might occur if the whole inner surface of the one or more target magnet 415 is in contact with the corresponding surface of one or more guide planes 417. Alternatively, a stop (not shown) might be formed directly on the rigid support arch 400.

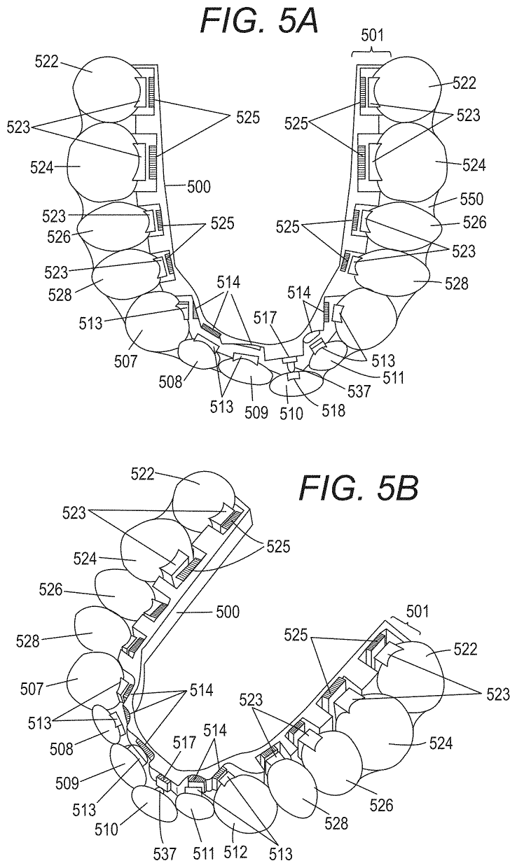

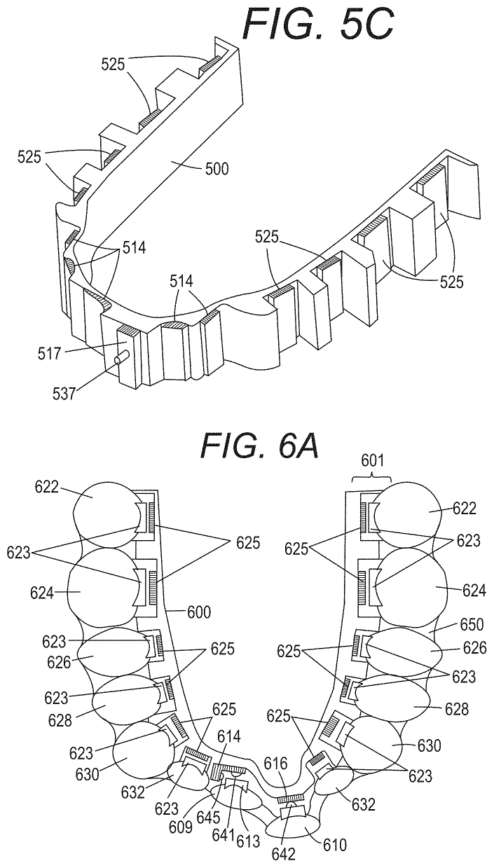

In the embodiment of FIGS. 5A-C a magnet-based orthodontic appliance system 501 includes at least one attachment magnet 523 configured to be attached to the lingual or palatal side of at least one respective support tooth 522, 524, 526 and 528 of a set of teeth 550. The magnet based orthodontic appliance system 501 includes a rigid support arch 500 having at least one respective mounting magnet 525 corresponding to and for magnetic attraction to at least one respective attachment magnet 523. The support arch 500 is secured in position by the attractive magnetic forces between the mounting magnets 525 and attachment magnets 523. First and second docking components comprise the attachment magnets 523 and mounting magnets 525.

The rigid support arch 500 supports at least one therapeutic magnet 514 at a respective at least one therapeutic position corresponding to at least one respective target magnet 513 attached to the palatal or lingual side of the at a respective at least one target tooth 507-509, 511 and 512. The therapeutic magnets 514 and target magnets 513 are configured to have similar magnetic poles facing each other so that a repulsive force pushes the teeth 507 and 512 laterally and teeth 508, 509 and 511 labially and/or forward to expand the dental arch and create space for the one or more crowded or blocked out tooth 510. In the illustrated embodiment a space is created for tooth 510 by labial or lateral movement of multiple teeth 507-509, 511 and 512. The support arch 500 also supports a therapeutic magnet 517 at a therapeutic position corresponding to the target magnet 518 attached to the lingual surface of target tooth 510. The therapeutic magnet 517 and target magnet 518 are configured to have opposite poles facing each other so that the therapeutic magnet 517 and target magnet 518 tend to attract each other. However, one or more stops 537 located, for example, on the therapeutic magnet 517, would prevent the lingual movement of target tooth 510. Accordingly, the tooth 510 would be held in its position while the teeth 507-509, 511 and 512 are urged forward and/or laterally by the interaction between their respective target and therapeutic magnets. It is noted that the rigid support arch 500 also includes stop arch extensions (unnumbered) that are similar to the stop arch extensions 103 of FIGS. 1A-C.

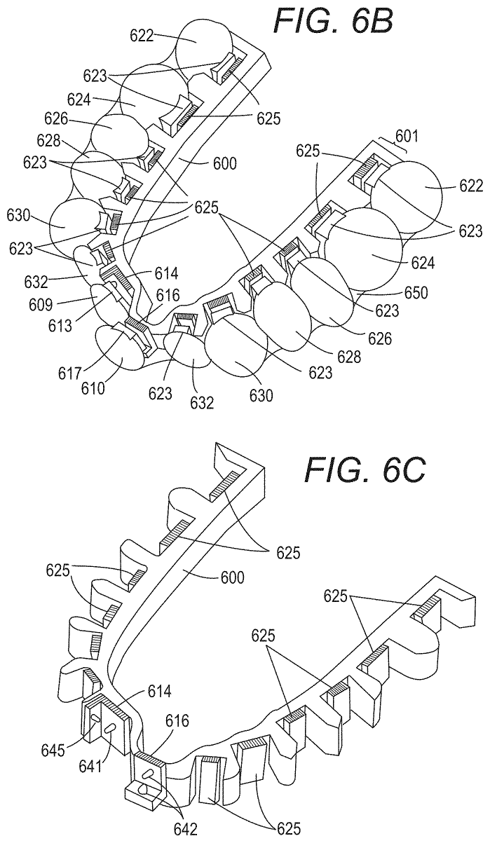

In the embodiment of FIGS. 6A-C twelve teeth 622, 624, 626, 628, 630 and 632 of a set of teeth 650 are used for supporting a rigid support arch 600 of a magnet based orthodontic appliance system 601. The magnet based orthodontic appliance system 601 includes at least one mounting magnet 625 supported by the rigid support arch 600. For instance, twelve mounting magnets 625 attached to the rigid support arch, correspond to, and are for magnetic attraction to twelve attachment magnets 623 mounted on the support teeth. First and second docking components comprise the attachment magnets 623 and mounting magnets 625. The support arch 600 is secured in position by the attractive magnetic forces between the mounting magnets 625 and attachment magnets 623. As discussed with regard to FIGS. 1A-C (see 103), and illustrated in the figures discussed above and many of the figures to be discussed below, those same attractive magnetic forces can be opposed by extensions 603 extending from the rigid support arch 601 and configured to contact the lingual surfaces of the support teeth 622, 622, 624, 626, 628, 630 and 632, thereby preventing the attractive forces between the mounting magnets and the attachment magnets from causing movement of the support teeth 622, 624, 626, 628, 630 and 632 towards the support arch.

The rigid support arch 600 is configured to support a therapeutic magnet 614 at a therapeutic position corresponding to target magnets 613 attached to a palatal side of a target tooth 609. The therapeutic magnet 614 is non-planar. That is, therapeutic magnet 614 is L-shaped in cross section when viewed from the top and is configured to have a larger leg attached to the rigid support arch while a smaller leg is configured to face a lateral edge of the target magnet. The shape and dimensions of the legs are determined by the amount and direction of the force required. The therapeutic magnet 614 and target magnet 613 are configured to have opposite poles face each other so that attractive forces between the target and the smaller leg of the therapeutic magnet might urge (e.g., pull) the target tooth 609 laterally to create space for adjacent target tooth 610. The therapeutic magnet 614 has stop 641 on the larger leg and stop 645 on the smaller leg which prevent the direct approximation of the facing surfaces of the therapeutic magnet 614 and target magnet 613. For example, as illustrated, the stop 641 contacts the target magnet, thereby preventing movement of the target tooth backward toward the longer leg of the therapeutic magnet 614. However, initially, the stop 645 is spaced from the lateral edge of the target magnet, thereby allowing for lateral movement toward the smaller leg of the L-shaped therapeutic magnet 614.

The support arch 600 also supports a therapeutic magnet 616 at a therapeutic position corresponding to a target magnet 617 attached to the lingual surface of target tooth 610. The therapeutic magnet 616 is non-planar. The therapeutic magnet 616 is L-shaped in cross section when viewed from the side and is configured to have a larger leg attached to the rigid support arch while a smaller leg is configured to face a bottom edge (as viewed in FIG. 6) of the target magnet 617. The shape and dimensions of the legs are determined by the amount and direction of the force required. The therapeutic magnet 616 and target magnet 617 are configured to have opposite poles face each other so that attractive forces between the target and the smaller leg of the therapeutic magnet might urge the target tooth downward so that the target tooth 610 will extrude and the larger leg might urge the target tooth backward into the space created by the lateral movement of the target tooth 609. The therapeutic magnet 616 also has one or more stops 642 which prevents the direct approximation of the facing surfaces of the therapeutic magnet 616 and target magnet 617 as the target tooth 610 moves down and back. It is noted that the rigid support arch 600 of the illustrated embodiment would be removed by the patient by pulling it downward, away from the upper teeth.

In some embodiments, similar magnetic forces may be beneficially generated using L-shaped target magnets and generally planar therapeutic magnets.

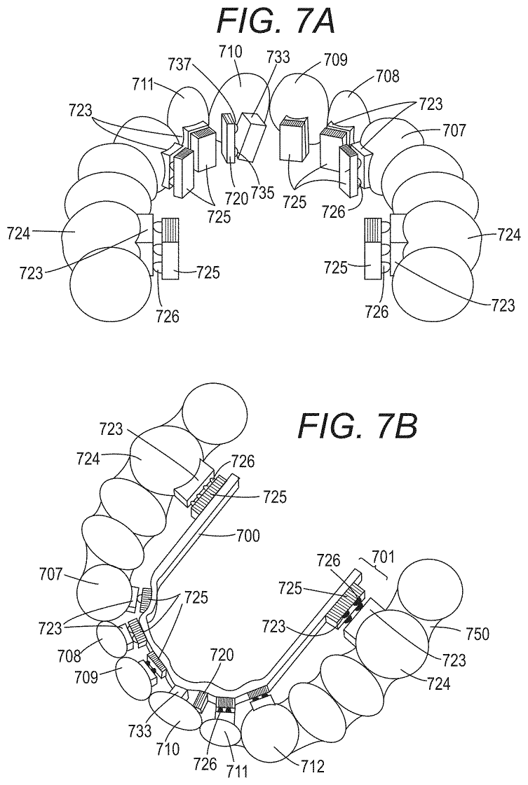

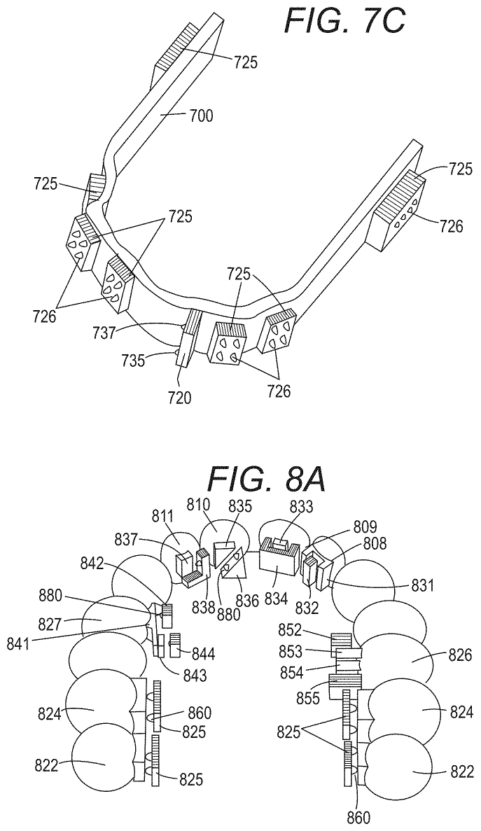

In the embodiment of FIGS. 7A-C, a magnet-based orthodontic appliance system 701 includes at least one attachment magnet 723 configured to be attached to the lingual or palatal side of at least one support tooth 724, 707-709, 711 and 712 of a set of teeth 750. In the illustrated embodiment, seven support teeth 724, 707-709, 711 and 712 are used. The magnet based orthodontic appliance system 701 includes a rigid support arch 700 having respective at least one mounting magnet 725 corresponding to and for magnetic attraction to at least one attachment magnet 723 secured to the at least one support tooth 724, 707-709, 711 and 712. The at least one mounting magnet 725 has at least one stop 726 included thereon. In the illustrated embodiment, the stops 726 are configured to prevent the direct approximation of facing surfaces of the mounting magnets 725 and attachment magnets 723. The support arch 700 is secured in position by the attractive magnetic forces between the mounting magnets 725 and attachment magnets 723.

The rigid support arch 700 supports a therapeutic magnet 720 at a therapeutic position corresponding to a target magnet 733 attached to the palatal or lingual side of a target tooth 710. The target magnet 733, which is attached along and aligned with the long axis of the target tooth 710, is at an angle relative to the therapeutic magnet 720 which is held substantially perpendicular to the occlusal plane. The therapeutic magnet 720 has two stops 735 and 737. Lower (as shown in the figure) stop 735 is closer to the incisal edge of the tooth 710 near the bottom of the face of the therapeutic magnet facing the target magnet. Due to the angle of the target tooth 710 and target magnet, the lower stop 735, which is closer to the incisal edge of the tooth 710, is closer to target magnet 733 than is upper stop 737. In the illustrated scenario, the lower stop 735 is in contact with the target magnet 733 so that the lower aspect of the tooth will not move toward the therapeutic magnet 720 due to the magnetic interaction between therapeutic magnet 720 and target magnet 733. During the treatment period, the lower stop 735 would act as a pivot point. There is a space between the upper stop 737 and the target magnet. Accordingly, the upper portion of the target magnet 733 is free to move toward the therapeutic magnet 720 until the target magnet 733 contacts the upper stop 737. As the inclination of the target tooth 710 becomes normal, the stops 735 and 737 would prevent the direct approximation of the facing surfaces of the therapeutic magnet 720 and target magnet 733.

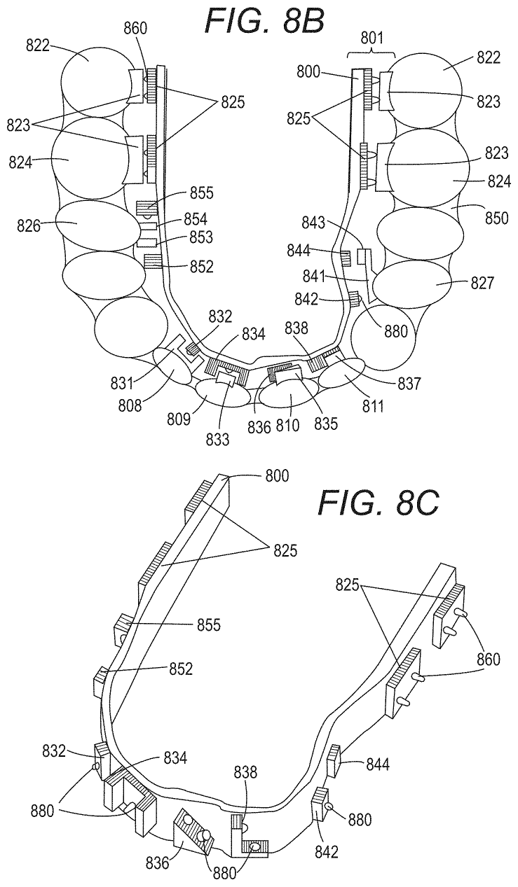

In the embodiment of FIGS. 8A-C a magnet-based orthodontic appliance system 801 includes at least one attachment magnet 823 configured to be attached, in the illustrated example, to the palatal side of at least one respective support tooth 822 and 824 of a set of teeth 850. The magnet based orthodontic appliance system 801 includes a rigid support arch 800 having respective at least one mounting magnet 825 corresponding to and for magnetic attraction to at least one attachment magnet 823. The support arch 800 is secured in position by the attractive magnetic forces between the mounting magnets 825 and attachment magnets 823. The at least one mounting magnet 825 carry at least one stop 860 which contact the at least one attachment magnet 823, thereby preventing the direct approximation of the facing surfaces of the mounting magnets 825 and attachment magnets 823.

The rigid support arch 800 is configured to support multiple therapeutic magnets in varying shapes at therapeutic positions corresponding to different target magnets attached to the palatal side of the various target teeth for specific tooth movement. For example, an L-shaped therapeutic magnet 838 that is attached at therapeutic position corresponding to a bar shaped target magnet 837 on the palatal surface of a tooth 811 in an attraction mode would urge the tooth 811 occlusally and mesially.

A triangular therapeutic magnet 836 that is attached at therapeutic position corresponding to a complementary triangular shaped target magnet 835 on the palatal surface of a target tooth 810. The complementary triangular shapes allow respective hypotenuses of the triangular shapes to be configured to face each other in, for example, an attraction mode to allow, for example, the tooth 810 to be urged both occlusally and mesially.

Non-planar therapeutic magnet 834, which might be described as C or U-shaped in cross section, is attached at a therapeutic position corresponding a bar shaped target magnet 833 attached to the palatal surface of a target tooth 809 in an attraction mode and would urge the target tooth 809 palatally. A planar or bar shaped therapeutic magnet 832 which is attached at therapeutic position corresponding to a U or C shaped target magnet 831 on the palatal surface of target tooth 808 in an attraction mode, would urge the target tooth 808 palatally. The three walls of the C or U-shaped magnet 834 may generate forces that urge the target magnet toward the center of the C or U in a left and right sense, thereby providing a multi-dimensional control on the position of the target magnet 833 and hence the target tooth 809. Modifying the C or U-shaped magnet to include a fourth and fifth wall (not shown) as a top and bottom to the therapeutic magnet (as viewed in the figure) to arrive at a box-shape might be used to additionally provide centering forces in the vertical direction. A similar effect might be achieved with a non-planar therapeutic magnet that is bowl-shaped. Alternatively, the target might be configured to be C, U, box or bowl-shaped and the therapeutic magnet might be bar shaped to achieve similar and corresponding forces and therapy. Similar centering effects might be achieved if the therapeutic and target magnets were configured to produce repulsive force vectors.

A therapeutic magnet 852 is attached at a therapeutic position corresponding to a first target magnet 853 on target tooth 826. The therapeutic magnet 852 and the first target magnet 853 are arranged in a repulsion mode so that the magnetic interaction between the first target magnet 853 and the first therapeutic magnet 852 urge the palatal side of target tooth 826 distally, thereby urging a derotation of the target tooth 826. In regard to the same target tooth 826, a second therapeutic magnet 855 is arranged at a therapeutic position corresponding to a second target magnet 854, which is also mounted on the palatal side of target tooth 826, in an attraction mode so that magnetic interaction between the therapeutic magnet 855 and the target magnet 854 would urge the palatal side of the target tooth 826 distally, augmenting the derotation force provided by the repulsive interaction between the first therapeutic magnet 852 and target magnet 853.

A therapeutic magnet 842 is also arranged at a therapeutic position corresponding to target magnet 841 on target tooth 827 in an attractive mode. The target magnet 841 includes a portion mounted to the target tooth 827 and a second portion or generally horizontal lever arm 865 that extends away from the mounted portion of the target magnet 841 back in the general direction of support teeth 824 and 822, yet angled a bit palatally due to a posture of the target tooth 827. A second therapeutic magnet 844 for the target tooth 827 is arranged at a therapeutic position corresponding to an additional magnetic attachment 843 near a distal end of the generally horizontal lever arm 865 of the target magnet 841. The second therapeutic magnet 844 is arranged in a repulsive configuration relative to the target magnet 841 and additional magnetic attachment 843 so that the combined effect of the magnetic interactions would derotate the tooth 827. The generally horizontal lever arm 865 of the target magnet 841 allows positioning of the additional attachment 843 far from the center of the tooth so that mechanical advantage of a resulting moment arm can be taken advantage of to bring about the derotation of the target tooth 827.

Therapeutic magnets shown in the FIGS. 8A-C (e.g., 825, 855, 832, 838, 842) have stops 880 which prevent direct approximation between the approximating surfaces of the therapeutic magnets and the target magnets.

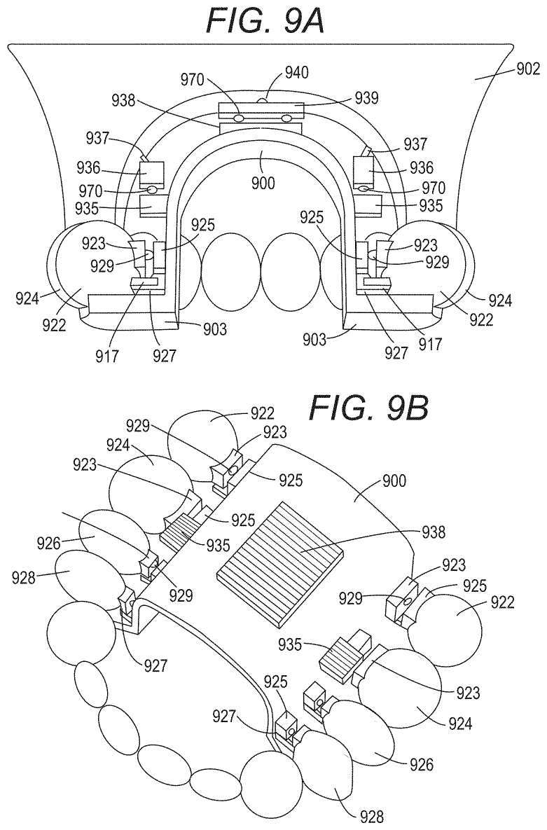

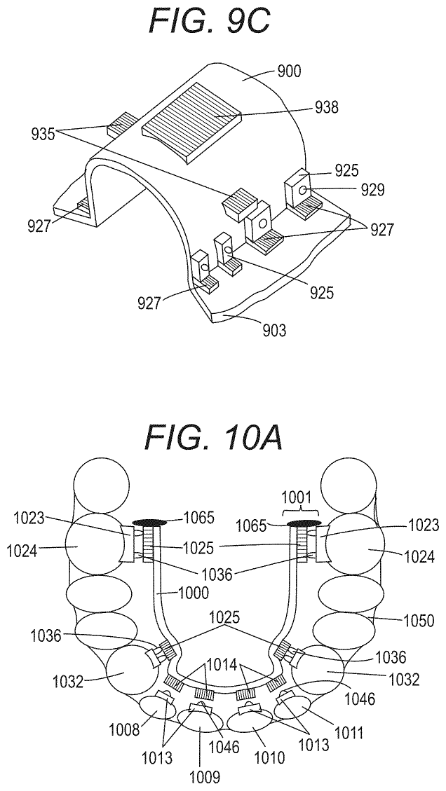

In the embodiment of FIGS. 9A-C, a magnet-based orthodontic appliance system 901 includes at least one attachment magnet 923 configured to be attached to the palatal side of at least one respective support tooth 922, 924, 926 and 928 from a set of teeth 950. In the illustrated embodiment, the support teeth 922, 924, 926 and 928 are also target teeth 922, 924, 926 and 928. The magnet-based appliance system also includes at least one or more target magnets 917 attached occlusal to the one or more mounting magnets 923. The magnet based orthodontic appliance system 901 includes a rigid support arch 900 having respective at least one mounting magnet 925 corresponding to and for magnetic attraction to the at least one attachment magnets 923. The rigid support arch 900 is configured to follow the contour of the palate of the patient rather than, or in addition to, the contour of a portion of the set of teeth 950. The support arch includes occlusal extension 903 which cover the occlusal surfaces of the one or more support/target teeth 922, 924, 926 and 928. The support arch 900 is secured in position by attractive magnetic forces between the mounting magnets 923 and attachment magnets 925. The one or more stops 929 on the one or more mounting magnets prevent the direct approximation of the facing surfaces of the one or more mounting magnets 925 and the corresponding attachment magnets 923. The occlusal extension 903 of the support arch 900 also has one or more therapeutic magnets 927 in therapeutic positions corresponding to the occlusal surface of the target magnets 917 attached to the palatal side of the target teeth 922, 924, 926 and 928.

The rigid support arch 900 is also configured to support at least one therapeutic magnet 935 and 938 at therapeutic positions corresponding to at least one implant magnet 936 and 939 attached to at least one orthodontic mini implant 937 and 940 implanted in the bony palate 902. The attractive force between the therapeutic magnets 935 and 938 and implant magnets 936 and 939 is carried by the rigid support arch to the occlusal extensions and thereby urges the support/target teeth 922, 924, 926 and 928 toward the bony palate 902. Though the at least one therapeutic magnets 935 and 938 are urged toward the implant magnets 936 and 939, the facing surfaces of these magnets will not directly approximate due to one or more stops 970 present on, for example, the one or more implant magnets 936 and 939. The therapeutic magnets 927 and the target magnets 937 are arranged in a repulsive configuration so that the support teeth/target teeth 922,924,926 and 928 are pushed towards the bone 902. The repulsive force between the one or more therapeutic magnets 927 and target magnets 937 will not move the support arch 900 away as it is kept in position by the attractive forces between the therapeutic magnets 935 and 938 and the respective target magnets 936 and 939. Also, the attractive forces between the mounting magnets 925 and attachment magnets 923 will ensure that the target teeth 922,924,926 and 928 will move gingivally into the bone along a plane guided by the vertical orientation of the mounting magnets 925.

It is noted that a similar assembly of therapeutic magnets and target magnets could be used to intrude the whole set of teeth 950, front teeth, posterior teeth in either and/or both dental arches with the help of orthodontic mini implants and implant magnets at the appropriate sites in upper jaw, lower jaw or both.

In the embodiment of FIGS. 10A-C, a magnet-based orthodontic appliance system 1001 includes at least one attachment magnet 1023 configured to be attached to the lingual or palatal side of at least one respective support tooth 1024 and 1032. The magnet based orthodontic appliance system 1001 includes a rigid support arch 1000. For example, the rigid support arch is made of orthodontic wire or metallic rod of appropriate size and rigidity. For instance, in some applications, the wire or rod commonly used in orthodontic headgear may provide sufficient rigidity. Rod or wire with a diameter of about 0.045 to about 0.06 inches or more may be appropriate. In some applications, thinner wire may suffice. Other embodiments might be injection molded or cast plastic or 3D printed (made through additive manufacturing). Machined embodiments are also possible. The rigid support arch 1000 is configured to support at least one mounting magnet 1025 corresponding to and for magnetic attraction to at least one attachment magnet 1023. The support arch 1000 is secured in position by the attractive magnetic forces between the mounting magnets 1025 and attachment magnets 1023. At least one stop 1036 on the attachment magnets 1023 prevent the direct approximation of the facing surfaces of the mounting magnets 1025 and the attachment magnets 1023, thereby preventing any movement of the support teeth 1024 and 1032 due to the magnetic interaction between the mounting magnets 1025 and attachment magnets 1023. The rigid support arch 1000 is also configured to include at least one extension which forms a sagittal stabilization stop 1065 that is configured to contact the distal surface of one or more attachment magnets 1023 on the one or more support teeth 1024.

The rigid support arch 1000 supports at least one therapeutic magnet 1014 at at least one therapeutic position corresponding to at least one target magnet 1013 attached to the palatal or lingual side of at least one target tooth 1008-1011. In the illustrated embodiment, four target teeth 1008-1011, which are front teeth, are addressed. An attractive force between the therapeutic magnets 1014 and target magnets 1013 tends to retract the target teeth 1008-1011 backward toward the rigid support arch 1000 which, as indicated above, is stabilized by the magnetic interaction between the mounting magnets 1025 and the attachments magnets 1023 on the support teeth 1024 and 1032 and is prevented from moving forward by the sagittal stabilization stops 1065 which embrace a rear most surfaces of attachment magnets 1023. For instance, the sagittal stabilization stops 1065 prevent the rigid support arch 1000 from moving forward due to the magnetic interaction between the therapeutic magnets 1014 and target magnets 1013. The stops 1046 on the target magnets 1013 would prevent a flush contact, or direct approximation, between the target magnets 1013 and the therapeutic magnets 1014 due to the teeth 1008-1011 being urged backward.

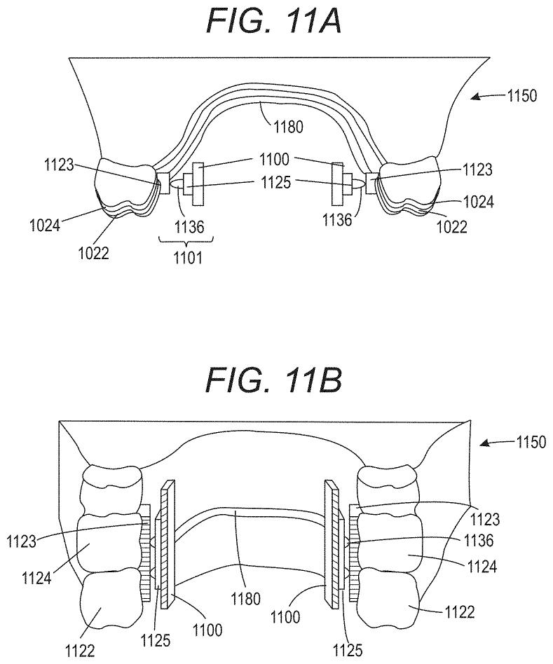

FIGS. 11A-B illustrate a set of teeth on one section of an upper dental arch 1150 in relation to a partial embodiment of a magnet-based orthodontic appliance system 1101 which uses cross arch stabilization using a trans-palatal arch 1180 and conjoined attachment magnets 1123. The phrase—partial embodiment—is used here to note that only part of the magnet-based orthodontic appliance system 1101 is illustrated. In the illustrated partial embodiment, a magnet based orthodontic appliance system 1101 includes at least one attachment magnet 1123 configured to be attached to the lingual or palatal side of at least two respective support teeth 1122 and 1124. The at least one attachment magnets 1123 in the illustrated embodiment are larger in dimension than attachment magnets of previously described embodiments and can be described as conjoined attachment magnets to be attached to two or more teeth 1122 and 1124 on each side of the arch. Alternatively, attachments magnets 1123 can be considered to be attachment magnets that are larger than those described above and configured to be attached to a plurality of support teeth. The attachment magnets 1123, on either side of the arch, are connected by a rigid trans-palatal arch 1180 in order to provide cross arch stabilization. The appliance system 1101 also includes a rigid support arch 1100 (only partially illustrated) configured to support respective at least one mounting magnet 1125 corresponding to, and for magnetic attraction to, the at least one attachment magnet 1123. At least one stop 1136 present on the at least one mounting magnet 1125 are configured to prevent the direct approximation of the facing surfaces of the mounting magnets 1125 and attachment magnets 1123. The cross-arch stabilization provided by the rigid transpalatal arch 1180, which is attached to two or more supporting teeth on either side of the arch would augment posterior anchorage when the rigid support arch is used for tooth movement with the help of therapeutic and target magnets. A similar cross arch stabilization can be provided in the lower dental arch as well.

For example, the trans-palatal arch 1180 might be made of orthodontic rod or wire. For example, in some applications, the wire or rod commonly used in orthodontic headgear may provide sufficient rigidity. Rod or wire with a diameter of about 0.045 to about 0.06 inches or more may be appropriate. In some applications, thinner wire may suffice. Other embodiments might be injection molded or cast plastic or 3D printed (made through additive manufacturing). Machined embodiments are also possible.

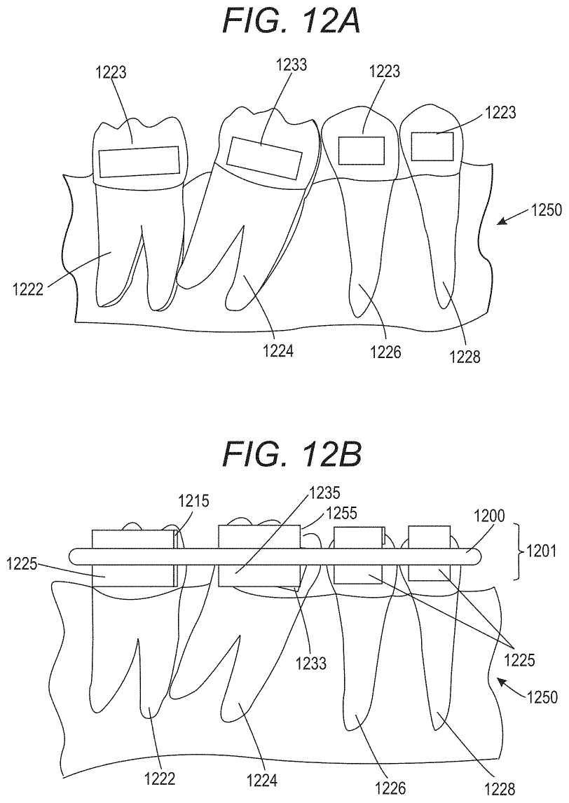

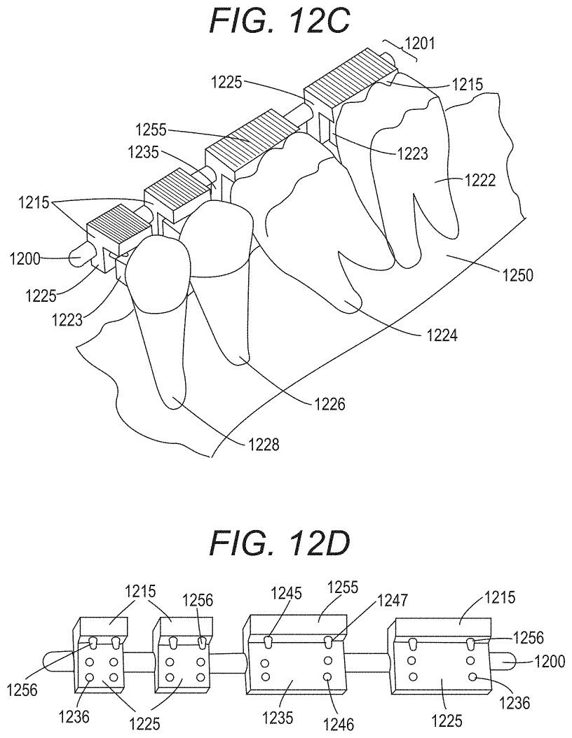

In the embodiment of FIGS. 12A-D a magnet-based orthodontic appliance system 1201 includes at least one first docking component, such as an attachment magnet 1223 configured to be attached to the lingual side of at least one respective support tooth 1222, 1226 and 1228. The magnet based orthodontic appliance system 1201 includes a rigid support arch 1200 having a respective at least one second docking component, such as mounting magnet 1225 corresponding to and for magnetic attraction to the at least one attachment magnets 1223. The rigid support arch 1200 is secured in position by the attractive magnetic forces between the mounting magnets 1225 and attachment magnets 1223. For example, the rigid support arch is made of orthodontic wire or metallic rod of appropriate size and rigidity. For example, in some applications, the wire or rod commonly used in orthodontic headgear may provide sufficient rigidity. Rod or wire with a diameter of about 0.045 to about 0.06 inches or more may be appropriate. In some applications, thinner wire may suffice. Other embodiments might be injection molded or cast plastic or 3D printed (made through additive manufacturing). Machined embodiments are also possible. The mounting magnets 1225 include horizontal extensions 1215 that are configured to extend from the mounting magnets 1225 over a second or top face (as viewed in the figures) of their respective attachment magnet 1223. At least one stop 1236 on the at least one mounting magnet 1225 contacts the lingual surface of the at least one attachment magnets 1223 and prevents lingual movement of the support teeth 1222, 1226 and 1228, whereas at least one stop 1256 (see FIG. 12D) on the horizontal extensions 1215 from the mounting magnets 1225 prevents vertical movement of the support teeth 1222, 1226 and 1228 due to the attractive magnetic forces between the mounting magnets 1225 and the attachment magnets 1223.

The rigid support arch 1200 is configured to support a therapeutic magnet 1235 at a therapeutic position corresponding to a target magnet 1233 attached to the lingual side of a target tooth 1224. The therapeutic magnet 1235 has a horizontal extension 1255 that extends over a second or top surface of the target magnet 1233, which results in, for example, and attractive force in a vertical plane to correct, for example, an angulation of the target tooth 1224. The therapeutic magnet 1235 also includes at least one stop 1246 configured to be in contact with the lingual surface of target magnet 1233 to prevent lingual movement of the target tooth 1224. It is noted that since lingual tooth movement is not desired in the illustrated scenario, the vertical portion of the therapeutic magnet 1235 need not actually be magnetic and may instead be a non-magnetic support for the horizontal extension 1255. However, due to manufacturing and inventory practicalities, the vertical portion of the therapeutic magnet 1235 may be magnetic and include stops 1246 to counteract the related magnetic force, as described above. The horizontal extension 1255 of the therapeutic magnet 1235 has two stops 1245 and 1247 on the surface approximating the top surface (as viewed in the figures) of target magnet 1233. The target magnet is substantially rectangular and is mounted with a long side substantially parallel to the occlusal surface of the crown of the target tooth 1224. However, the target tooth 1224 is tipped mesially at an angle relative to the direction of other teeth (e.g., 1222, 1226). Accordingly, the target magnet 1233 is at an angle relative to the orientation of the horizontal extension 1255. Therefore, the stop 1247 is positioned at a point that is closer to the top surface of the target magnet 1233 due to the angled nature of the target magnet 1223 and may even be configured to be in contact with the target magnet 1233, even initially, thereby preventing upward (as viewed in the figure) vertical movement of the corresponding side of the target tooth 1224. The stop 1245 is positioned above (as viewed in the figures) the lower side of the target magnet 1223. A resulting space between the stop 1245 and the top surface of the target magnet 1223 allows an extrusive movement of that side of the tooth 1224, due to attractive forces between the horizontal extension 1255 and the target magnet 1223, until there is a contact between the target magnet 1233 and the stop 1245, at which point the angulation of the tooth 1224 would be corrected.

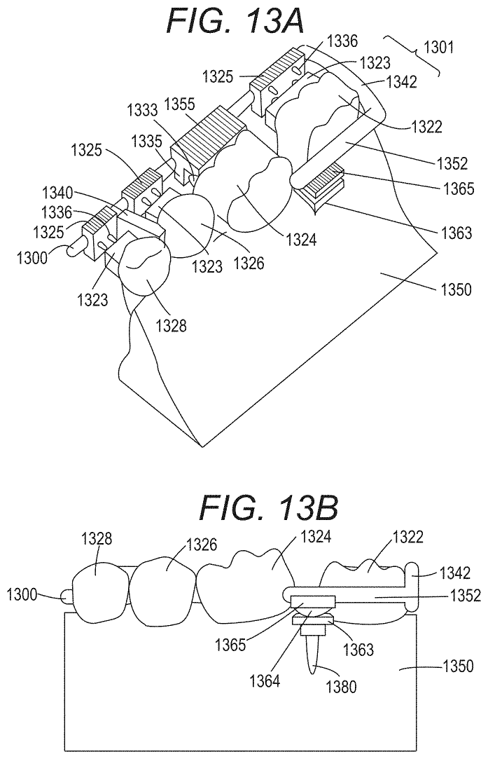

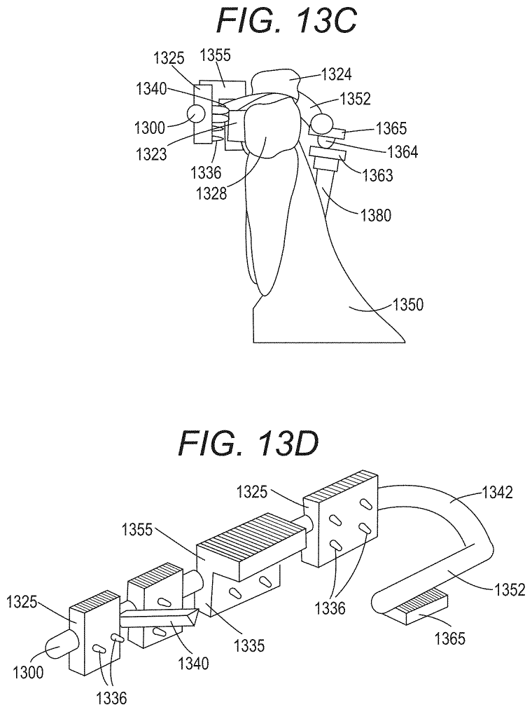

In the embodiment of FIGS. 13A-D, a magnet-based orthodontic appliance system 1301 includes at least one first docking component, such as an attachment magnet 1323 configured to be attached to the lingual side of at least one respective support tooth 1322, 1326 and 1328. The magnet based orthodontic appliance system 1301 includes a rigid support arch 1300 having respective at least one second docking component, such as mounting magnet 1325 corresponding to and for magnetic attraction to the at least one attachment magnet 1323. The rigid support arch may be made of, for example, orthodontic wire or a metallic rod, or any of the plastics or 3D printed materials discussed above with regard to FIGS. 10-12. The rigid support arch 1300 is secured in position by the attractive magnetic forces between the mounting magnets 1325 and attachment magnets 1323. At least one stop 1336 on the at least one mounting magnet 1325 contacts the lingual surface of the at least one attachment magnets 1323. The stops 1336 prevent movement of the support teeth 1322, 1326 and 1328 due to the attractive magnetic forces between the mounting magnets 1325 and the attachment magnets 1323.

The rigid support arch 1300 is configured to support a therapeutic magnet 1335 at a therapeutic position adjacent a target magnet 1333 attached to the lingual side of a target tooth 1324. The therapeutic magnet 1335 includes a horizontal extension 1355 configured to produce a force component in a vertical plane to correct, for example an angulation of the target tooth 1324 by magnetic interaction between the therapeutic magnet 1335 and target magnet 1333. The rigid support arch 1300 is configured to support a horizontal extension 1340 that is configured to contact an occlusal surface between, for example, the support teeth 1326 and 1328. The rigid support arch 1300 is also configured to include a distal extension 1342 configured to contact an occlusal surface of the support tooth 1322 and further extend as buccal extension 1352 to embrace a buccal surface of the support tooth 1322. The buccal extension 1352 of the support arch supports one or more stabilizing magnets 1365 which is placed at a stabilizing position approximating a stabilizing implant magnet 1363 mounted on a mini-implant 1380 mounted in a buccal bone 1350 of the patient. At least one stop 1364 on the stabilizing magnet 1365 prevents direct approximation of the stabilizing magnet 1365 and the stabilizing implant magnet 1363. The extensions 1340 and 1342 of the support arch 1300 provide vertical stabilization for the support arch while the magnetic interaction between the horizontal extension 1355 of the therapeutic magnet 1335 and target magnet 1333 corrects the angulation of the tooth 1324.

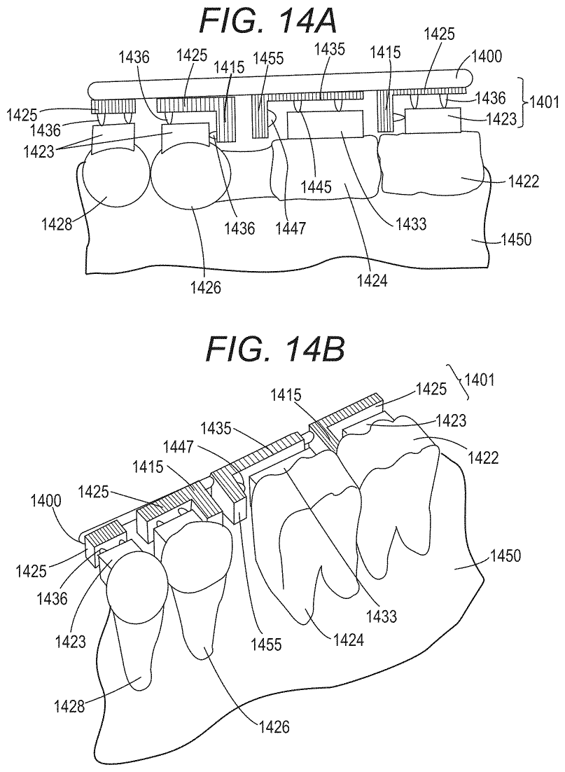

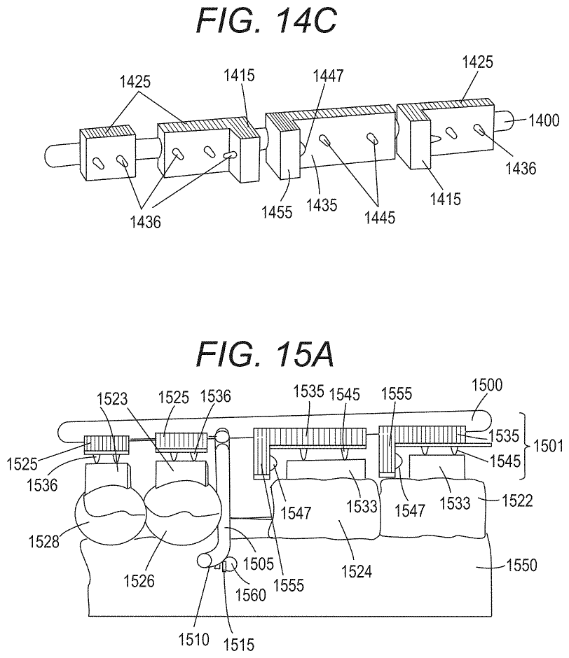

In the embodiment of FIGS. 14A-C, a magnet-based orthodontic appliance system 1401 includes at least one first docking component, such as attachment magnets 1423 configured to be attached to the lingual side of at least one respective support tooth 1422, 1426 and 1428 of a set of teeth 1450. The magnet based orthodontic appliance system 1401 includes a rigid support arch 1400 having respective at least one second docking component, such as mounting magnets 1425 corresponding to and for magnetic attraction to at the east one attachment magnets 1423. The rigid support arch 1400 is secured in position by attractive magnetic forces between the mounting magnets 1425 and the attachment magnets 1423. The rigid support arch may be made of, for example, orthodontic rod or wire, or any of the plastics or 3D printed materials discussed above with regard to FIGS. 10-12. The mounting magnets 1425 associated with the support teeth 1422 and 1426 have horizontal extensions 1415 facing distal and the mesial surfaces of the attachment magnets 1423 on the respective teeth 1422 and 1426, respectively. The extensions 1415 give the mounting magnets an L-shaped cross-sectional appearance. Stops 1436 on the at least one mounting magnet 1425 are configured to contact the approximating surface of the one or more attachment magnets 1423 thereby preventing lingual or mesiodistal movement of the support teeth 1422, 1426 and 1428 due to the attractive magnetic forces between the mounting magnets 1425 and the attachment magnets 1423.

The rigid support arch 1400 is configured to support a therapeutic magnet 1435 at a therapeutic position corresponding to a target magnet 1433 attached to the lingual side of a target tooth 1424. The therapeutic magnet 1435 includes an extension 1455 on a mesial side facing a mesial surface of the target magnet 1433. At least one stop 1445 on the therapeutic magnet 1435 is configured to be in contact with a lingual surface of target magnet 1433 acts as a stop to prevent lingual movement of the target tooth 1424. Stops 1447 on the extension 1455 of the therapeutic magnet 1435 are initially spaced from an approximating mesial surface of the target magnet 1433, initially allowing the target tooth 1424 to be urged mesially in response to a magnetic attraction between the extension 1455 of the therapeutic magnet 1435 and the target magnet 1433.

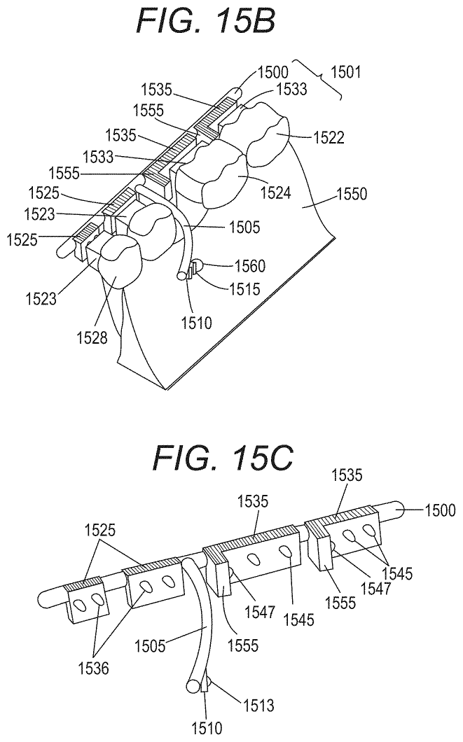

In the embodiment of FIGS. 15A-C a magnet-based orthodontic appliance system 1501 includes at least one attachment magnet 1523 configured to be attached to the lingual side of at least one respective support tooth 1526 and 1528 of a set of teeth 1550. The magnet based orthodontic appliance system 1501 includes a rigid support arch 1500 having respective at least one mounting magnet 1525 corresponding to and for magnetic attraction to the at least one attachment magnet 1523. The rigid support arch is, for example, made orthodontic wire or a metallic rod of appropriate size and rigidity. For example, in some applications, the wire or rod commonly used in orthodontic headgear may provide sufficient rigidity. Rod or wire with a diameter of about 0.045 to about 0.06 inches or more may be appropriate. In some applications, thinner wire may suffice. Other embodiments might be injection molded or cast plastic or 3D printed (made through additive manufacturing). Machined embodiments are also possible. The support arch 1500 is secured in position by attractive magnetic forces between the mounting magnets 1525 and attachment magnets 1523. The mounting magnets 1525 associated with support teeth 1526 and 1528 include at least one stop 1536 that is configured to contact a lingual surface of the one or more attachment magnets 1523 and prevent lingual movement of the support teeth 1526 and 1528 due to the attractive magnetic forces between the mounting magnets 1525 and the attachment magnets 1523.

The rigid support arch 1500 is configured to support one or more therapeutic magnets 1535 at at least one therapeutic position corresponding to at least one target magnet 1533 attached to the lingual side of at least one target tooth 1522 and 1524. The therapeutic magnets 1535 may include extensions 1555, for example, on a mesial side approximating a mesial surface of the at least one target magnets 1533 attached to the lingual surface of the target teeth 1522 and 1524. The extensions 1555 may give the therapeutic magnets 1535 an L-shaped appearance or-cross-section. One or more stops 1545 on the one or more therapeutic magnets 1535 may be configured to contact the lingual surface of the at least one target magnets 1533, thereby preventing or limiting lingual movement of the support teeth 1522 and 1524. The extensions 1555 on the therapeutic magnets 1535 may also carry one or more stops 1547. The one or more stops 1547 may be configured to be initially spaced from an approximating surface of the target magnets 1533, thereby allowing the target teeth 1522 and 1524 to be urged mesially by a magnetic attraction between the one or more therapeutic magnet extensions 1555 and the target magnets 1533. The support arch 1500 may be further configured to include a horizontal extension 1505, for example, configured to abut a disto-occlusal surface of, for example, support tooth 1526, thereby providing further stabilization. For instance, the horizontal extension 1505 of the rigid support arch 1500 may be configured to reach through a space or gap between teeth to support at least one stabilizing magnet 1510 at a stabilizing position corresponding to a stabilizing implant magnet 1515 mounted on a mini-implant 1560 implanted in buccal bone 1580 of the patient. A stop 1513 on the stabilizing magnet 1510 may be configured to prevent direct approximation of the stabilizing magnet 1510 and the stabilizing implant magnet 1515.

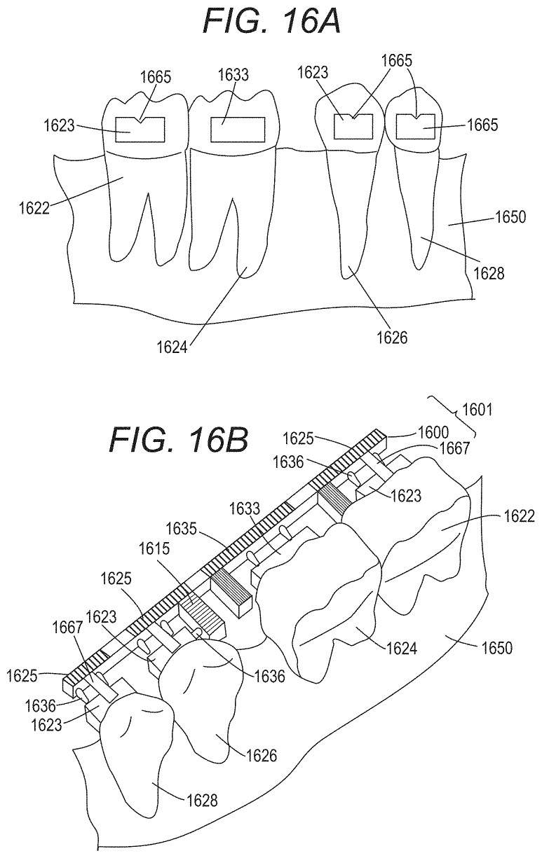

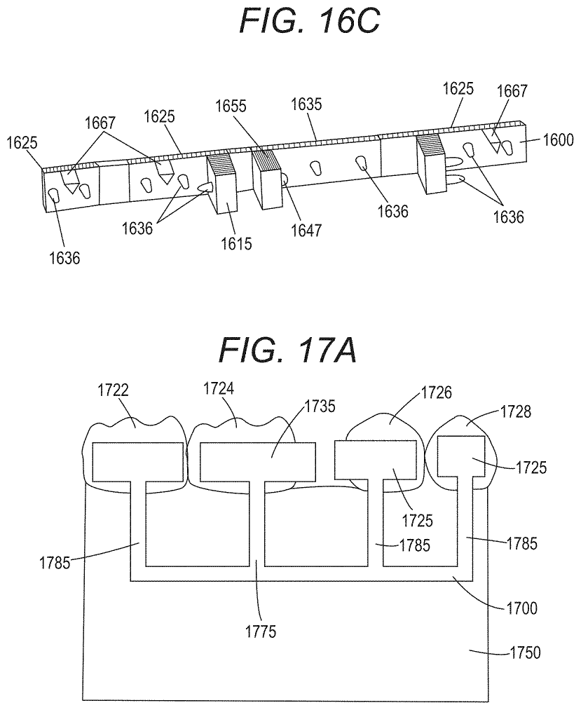

In the embodiment of FIGS. 16A-C, a magnet-based orthodontic appliance system 1601 includes at least one attachment magnet 1623 configured to be attached to the lingual side of at least one respective support tooth 1622, 1626 and 1628 of a set of teeth 1650. The attachment magnets 1623 have slots or seats 1665 that are configured to accept guide arms 1667 extending from mounting magnets 1625. The magnet based orthodontic appliance system 1601 includes a rigid support arch 1600 which can itself be a permanent magnet in the form of an arch shaped strip. Alternatively, the rigid support arch 1600 strip may be configured to have isolated magnetized regions. For instance, the rigid support arch might be made through additive manufacturing or 3D printing wherein all or only portions of the rigid support arch are formed from a ferromagnetic material or a suspension including ferromagnetic material. In either case, regions configured to be adjacent the attachment magnets 1623 act as or correspond to at least one mounting magnet 1625. Similar orientations can be made from orthodontic rod or wire. For example, in some applications, the wire or rod commonly used in orthodontic headgear may provide sufficient rigidity. Rod or wire with a diameter of about 0.045 to about 0.06 inches or more may be appropriate. In some applications, thinner wire may suffice. Other embodiments might be injection molded or cast plastic or 3D printed (made through additive manufacturing). Machined embodiments are also possible.

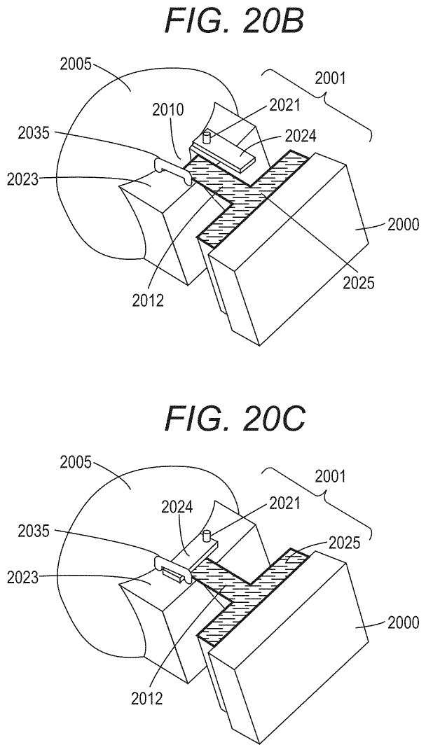

The rigid support arch 1600 is secured in position by attractive magnetic forces between the at least one mounting magnet 1625 and the corresponding at least one attachment magnet 1623. The rigid support arch 1600 and/or the one or more mounting magnets 1625, is configured to include at least one guide arms 1667 extending therefrom and configured to be received in the at least one respective slot or seat 1665 in the at least one attachment magnet 1623. The inclusion and use of guide arms 1667 and seats 1665 are a way for a patient to ensure the rigid support arch 1600 is properly positioned and installed. Proper seating can be felt during installation. At least one mounting magnet 1625, or at least one corresponding magnetized region of the support arch 1600 designated to be the same, can be configured to include horizontal mounting extensions 1615 for providing a mesio-distal support for the support teeth preventing their movement in the mesiodistal plane. For example, horizontal mounting extensions 1615 are illustrated in relation to the attachment magnets 1623 on support teeth 1622 and 1626. For instance, the horizontal mounting extensions 1615 can be configured to have stops 1636 which prevent or oppose mesio-distal movement of the support teeth 1622 and 1626. The one or more guide arms 1667 from the support arch 1600 or one or more mounting magnets 1625 can rest passively in their respective slots or seats 1665. In some embodiments, the one or more guide arms in the slots or seats might be secured with a lock or clip (e.g., see FIGS. 20A-C) so that the support arch might be removed only by a trained clinician and not by the patient. As in all embodiments, the attachment magnets and mounting magnets can instead be other first and second docking components. Using magnets as the docking components facilitates removal and installation by the patient. In instances where the support arch is secured to the support teeth with the help of a locking mechanism, ease of removal and installation by the patient is less of a concern and the convenience of magnetic first and the second docking components might be less of a consideration. The one or more guide arms 1667 provide guidance for placement of the support arch 1600 on the attachment magnets to provide appropriate orientation of the mounting magnets 1625 approximate to the attachment magnets 1623. Stops 1636 of the one or more mounting magnets 1625 which contact the approximating surfaces of the one or more attachment magnets 1623 prevent lingual or mesiodistal movement of the support teeth 1622, 1626 and 1628 due to the attractive magnetic forces between the mounting magnets 1625 and the attachment magnets 1623.

The rigid support arch 1600 which, as indicated above, can itself be an arch-shaped strip magnet, or have magnetic regions, can have regions corresponding to, for example, a therapeutic magnet 1635 at a therapeutic position adjacent to target magnet 1633 attached to the lingual side of target tooth 1624. The therapeutic magnet 1635 also has a therapeutic magnet extension 1655 on, for example, a mesial side facing a mesial surface of the target magnet 1633. At least one stop 1647 on the extension 1655 is initially spaced away from an approximating surface of the target magnet 1633, thereby allowing the target tooth 1624 to move mesially in response to the magnetic attraction between the therapeutic extension 1655 of the therapeutic magnet 1635 and the target magnet 1633.

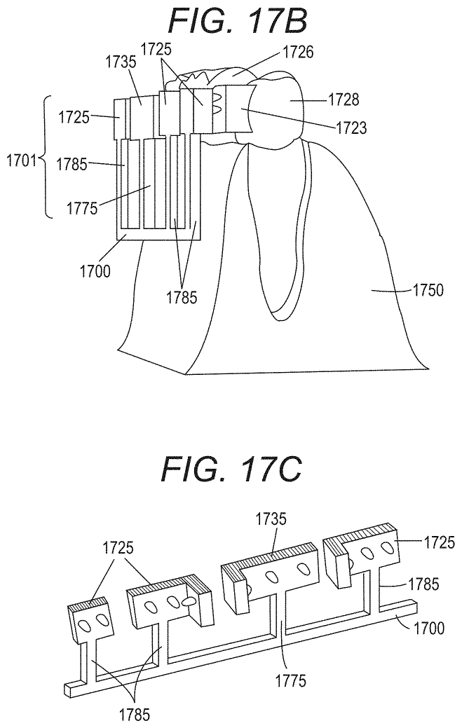

In the embodiment of FIGS. 17A-C, a magnet-based orthodontic appliance system 1701 includes at least one attachment magnet 1723 configured to be attached to the lingual side of at least one respective support tooth 1722, 1726 and 1728 of a set of teeth 1750. The magnet based orthodontic appliance system 1701 includes a rigid support arch 1700 having respective at least one mounting magnet 1725 corresponding to and for magnetic attraction to the at least one attachment magnet 1723. The rigid support arch 1700 is configured to be located gingival to the crown of the one or more teeth 1722, 1724, 1726 and 1728. For instance, the one or more mounting magnets 1725 are attached to the rigid support arch by vertical extensions 1785 in order to reach toward their respective attachment magnets 1723 from the gingival rigid support arch 1700. The rigid support arch 1700 also supports at least one therapeutic magnet 1735 at at least one therapeutic position corresponding to at least one target magnet (not shown) attached to the lingual side of a target tooth 1724. The at least one therapeutic magnet 1735 is attached to the rigid support arch 1700 by vertical extension 1775. For example, the rigid support arch 1700 and vertical extensions 1785, 1775 might be made from a stamping, such as a stamping or milling of a sheet of stainless steel or ferromagnetic material. Some embodiments might be cast, injection molded or made by additive manufacturing or 3D printing using thermoplastics and/or ferromagnetic suspensions in plastics or epoxies. Alternatively, embodiments might be assembled from sections of orthodontic wire or sheet metal welded or soldered together. Some embodiments may be unitary in that the magnets and rigid support arch 1700 are manufactured (e.g., by stamping, casting or additive manufacturing) as a single unit. Alternatively, the mounting and therapeutic magnets are attached as described previously (e.g., screws, brackets, cement, adhesives, etc.). Configuring the rigid support arch to be located gingival to the level of the teeth, as illustrated in FIGS. 17A-C reduces an in-out thickness of the appliance, thereby, for example, improving the tongue space and/or facilitates flossing of the teeth with the appliance in place.

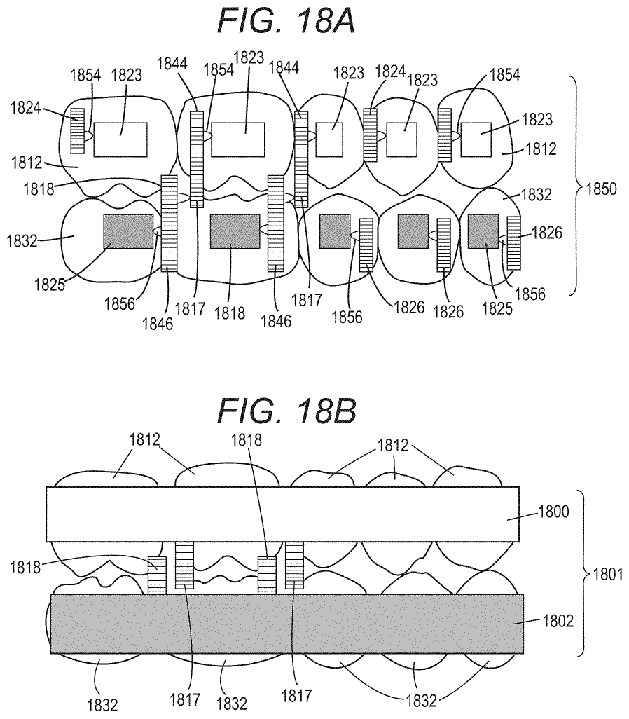

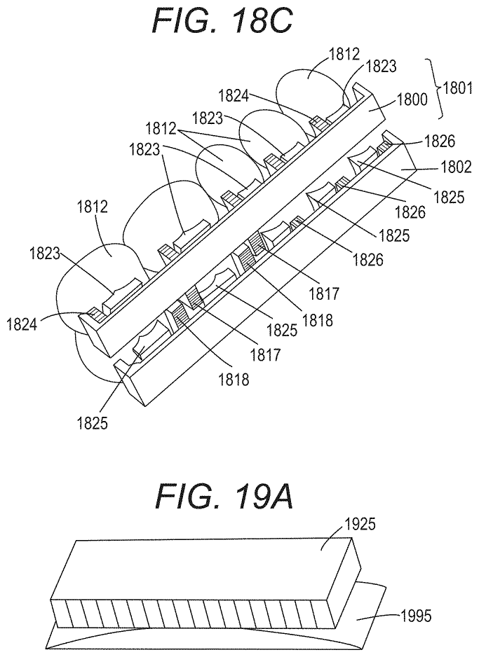

In the embodiment of FIGS. 18A-C a magnet-based orthodontic appliance system 1801 includes at least one attachment magnet 1823 configured to be attached to the lingual or palatal side of at least one respective upper support tooth 1812 of an upper arch of a patient. The magnet based orthodontic appliance system 1801 includes an upper rigid support arch 1800 having respective at least one upper mounting magnet 1824 and 1844 corresponding to and for magnetic attraction to the at least one upper attachment magnet 1823. The at least one upper mounting magnet 1844 include downward extensions 1817 that are configured to extend downward towards the lower arch of the patient. The upper rigid support arch 1800 is secured in position by attractive forces between the upper mounting magnets 1824 and 1844 and upper attachment magnets 1823. Stops 1854 of the upper mounting magnets 1824, 1844 prevent movement of the upper support teeth 1812 towards the upper mounting magnets 1824.

The magnet-based orthodontic appliance system 1801 also includes at least one lower attachment magnet 1825 configured to be attached to the lingual side of at least one respective lower support tooth 1832 of the lower arch. The magnet based orthodontic appliance system 1801 includes a lower rigid support arch 1802 having respective at least one lower mounting magnet 1826, 1846 corresponding to and for magnetic attraction to the at least one lower attachment magnet 1825. The lower mounting magnets 1846 have upward extensions 1818 extending towards the upper arch. The lower rigid support arch 1802 is secured in position by attractive forces between the lower mounting magnets 1826, 1846 and the lower attachment magnets 1825. Stops 1856 of the mounting magnets 1826, 1846 are configured to prevent the movement of the at least one lower support teeth 1832 toward the lower mounting magnets 1826.

The downward extensions 1817 of the upper mounting magnets 1844 of the upper arch and the upward extensions 1818 of the lower mounting magnets 1846 of the lower arch are configured to magnetically attract each other, thereby urging the upper arch and lower arch toward each other in an antero-posterior direction, thereby urging an improved inter-arch relationship.

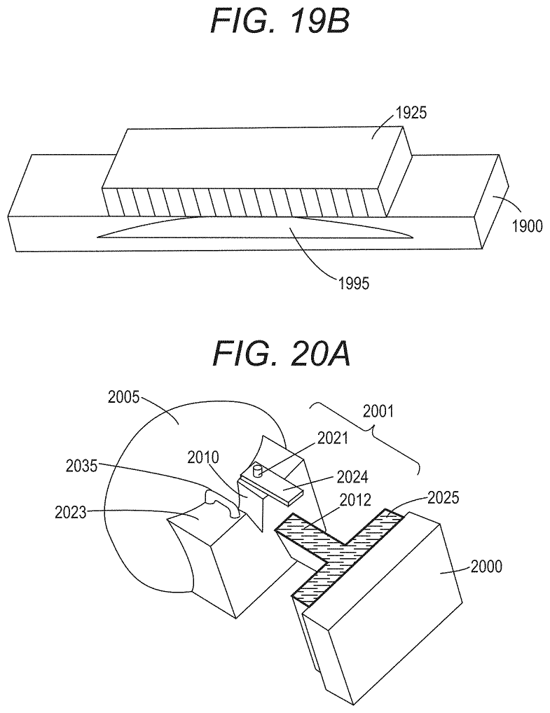

Both mounting and therapeutic magnets may be supported or affixed to embodiments of the rigid support arch in a variety of ways. For example, embodiments of the rigid support arch may include a pocket or groove for accepting and supporting a magnet. For instance, embodiments, including embodiments described herein above, may include an interlocking arrangement such as that described relative to FIGS. 19A-B wherein a magnet 1925 carries a dovetail or pin 1995 configured to be interlocked or mated with a corresponding recess, slot or half blind dovetail as illustrated in rigid support arch 1900 (see FIG. 19B). Other configurations for interlocking are contemplated. Such embodiments might allow clinicians to use a same rigid support arch for multiple stages of treatment as early treatment stage magnets could be replaced with later treatment stage magnets of various size, strength and/or dimensions as appropriate for a next stage of treatment or therapy.

As indicated above, for example, with regard to FIGS. 16A-C, there are scenarios where removal of an appliance by the patient needs to be prevented. In those instances, it can be beneficial to lock, secure or fix the orthodontic appliance in place, or at least discourage the patient from attempting removal. In this regard, it will be appreciated that the docking components may take a variety of forms, including, for example, magnetic or non-magnetic forms, and/or forms that include securing or fixing components.

FIGS. 20A-C illustrate an embodiment of a variation of docking components such as securing or fixing components 2001 of embodiments of the magnet-based orthodontic appliance system. The securing or fixing components 2001 include, for example, a mounting magnet 2025 illustrated on a portion of a rigid support arch 2000 fixed in place with the help of a door or latch 2024 and a spring clip 2035. For instance, an attachment magnet 2023 includes a slot or recess 2010 configured to receive a guide key 2012 extending from the mounting magnet 2025. For instance, the slot or recess 2010 is in a top portion of the attachment magnet 2023 and the guide key 2012 extends from a corresponding portion of the mounting magnet 2025. A door or latch 2024 is shown attached to the top portion of the attachment magnet with a screw 2021. With the screw 2021 loosely secured, the door 2024 is configured to be pivotable about the screw. The door 2024 is long enough to extend over a top of the slot or recess 2010. The guide key 2012 is configured to be placed in the slot or recess 2010. The door 2024 is configured to have a portion of the door positioned over the slot or recess 2010 and secured in place. For instance, the screw can be tightened to hold the door in place. In that state, a guide key installed in the slot or recess 2010 is prevented from being lifted out of the slot, thereby tending to secure or fix the mounting magnet 2025 and attached rigid support arch 2000 in place. Similar securing or fixing components included on one or more additional tooth and one or more corresponding additional portions of the rigid support arch 2000 might enhance the level of security or fixation. In addition to, or as an alternative to securing the door 2024 in place by the tightness of the screw 2021, in some embodiments, the door 2024 can be pivoted around the screw 2021 after insertion of the guide key 2012 and locked in place with a spring clip 2035, thereby fixing the guide key 2012, the mounting magnet 2025 and hence the rigid support arch 2000 in position.

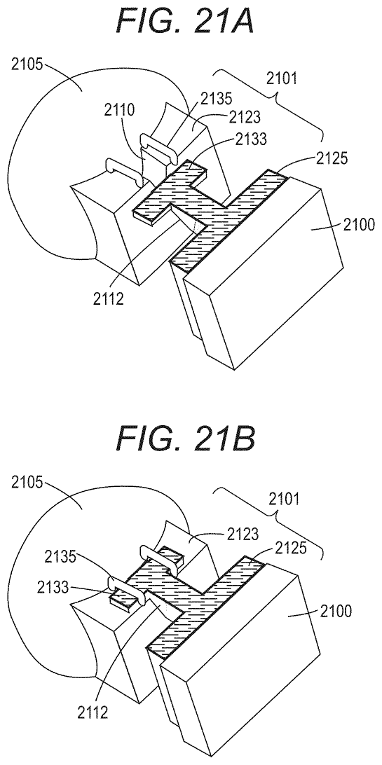

With reference to FIGS. 21A-B, another embodiment of docking components such as securing or fixing components 2101 of magnetic based orthodontic appliance system includes at least one attachment magnet 2123 which is configured to be attached to the lingual or palatal side of one or more support tooth 2105. The attachment magnet 2123 can include a recess or seat 2110 and one or more spring clips 2135 on the occlusal surface of the attachment magnet 2123. The illustrated magnetic based orthodontic appliance system 2101 includes a rigid support arch 2100 configured to support at least one mounting magnet 2125 corresponding to and for magnetic attraction to at least one attachment magnet 2123. The mounting magnet 2125 includes a fixing extension in the form a guide key 2112 with a stabilization member 2133. For instance, the recess, slot or seat 2110 has a shape such as the illustrated V-shape. The guide key 2112 has a corresponding shape, such as a solid V-shape that extends outward from and normal to the mounting magnet and is configured to be received in the seat 2110. The V-shape of the seat 2110 and the corresponding V-shape of the guide key are illustrative. The use of alternate mating shapes is contemplated. When viewed from the top, the stabilization member 2133 extends a first arm and a second arm out in opposite directions perpendicular to a top surface of a distal end of the V of the guide key, thereby forming a T-shape. The stabilization member 2133 is configured to rest on the occlusal surface of the attachment magnet 2123 when the guide key 2112 is inserted in the recess, slot or seat 2110. Once seated, the guide key can be captured and held in place by installation of at least one spring clip 2135 installed over a portion of the stabilization arm 2133. For instance, the attachment magnet 2123 is configured to accept the at least one spring clip 2135. In the illustrated embodiment, two spring clips are used. One spring clip 2135 captures the first arm of the stabilization member 2133 and the other spring clip captures the second arm of the stabilization member 2133. In this way, the spring clips 2135 hold the stabilization member 2133 of the guide key 2112 in place after the guide key 2112 is inserted into the recess or seat 2110 on the attachment magnet 2123, thereby securing the mounting magnet 2125 and hence the rigid support arch 2100 against the attachment magnet 2123 on the support tooth 2105. The T-shape and spring clips are illustrative. Other locking mechanisms are contemplated. Similar securing or fixing components included on one or more additional tooth and one or more corresponding additional portions of the rigid support arch 2100 might enhance the level of security or fixation.

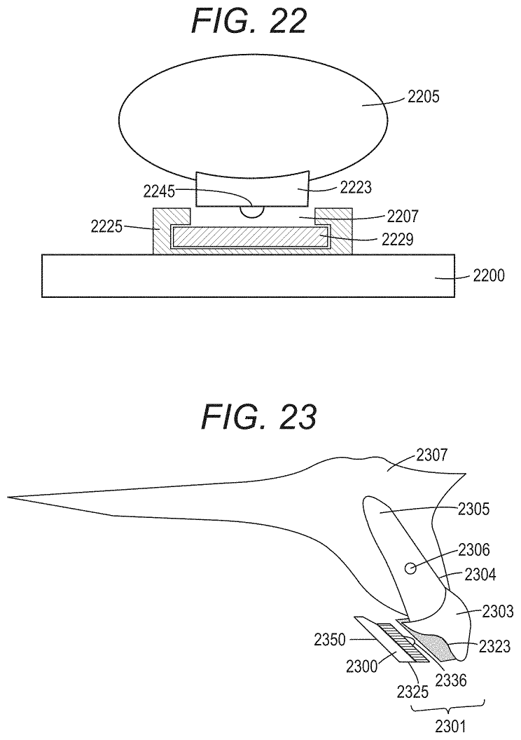

As indicated above, the various component magnets of embodiments of the magnet based orthodontic appliance system can be configured to have a wide variety of beneficial shapes and features. In addition to those features, embodiments of the magnets discussed herein can be configured to provide an adjustable level of force. For example, and with reference to FIG. 22, an embodiment of one or more component magnet of embodiments of the magnet based orthodontic appliance system comprises, for example, a modifiable therapeutic magnet 2225. In the illustrated embodiment, a target magnet 2223 is configured to be attached to the lingual or palatal surface of a tooth 2205. The target magnet 2223 carries a stop 2245. A rigid support arch 2200 supports a corresponding modifiable therapeutic magnet 2225. The therapeutic magnet 2225 includes a recess, slot or pocket 2207 configured to accept one or more additional magnets 2229. Such embodiments allow a range of force to be adjusted or customized reducing a need for custom manufacturing of magnets on a per patient and/or per treatment stage basis. Additionally, such embodiments allow a clinician to adjust applied forces for a particular patient over the course of treatment.

For example, if the target magnet 2223 and therapeutic magnet 2225 are configured to be in the attractive mode, the presence of additional magnet 2229 in the recess 2207 will allow the initial movement of the tooth 2205 towards the rigid support arch 2200. As the stop 2245 of the target magnet 2223 contacts the approximating surface of the additional magnet 2229, the movement of the tooth 2205 would stop. At this point, it may be beneficial for the clinician to reduce the therapeutic force, for example, in order to compensate for the reduced distance between the target magnet 2223 and the therapeutic magnet 2225. Accordingly, the clinician might remove the additional magnet 2229. With the additional magnet 2229 removed, the target magnet 2223 and hence the tooth 2205 can be urged to move at a therapeutically appropriate rate, further into the slot or pocket 2207 of the therapeutic magnet 2225.

In another scenario, if the target magnet 2223 and therapeutic magnet 2225 are configured to be placed in the repulsive mode, the additional magnet 2229 could be added later, after the repulsive force formed by the interactions between the therapeutic magnet 2225 and target magnet 2223 subside due to the increase in distance between the therapeutic magnet 2225 and the target magnet 2223 resulting from target tooth movement.

As with other features of magnets discussed herein throughout, while in the illustrated embodiment it is a therapeutic magnet that is modifiable, target magnets can be configured to be modifiable as well. Furthermore, scenarios wherein both therapeutic and target magnets are modifiable are contemplated.

FIG. 23 provides a cross-sectional view of a tooth 2304 along with a bony palate 2307 of a patient in relation to a cross-sectional view of a magnet based orthodontic appliance system 2301 used for retraction of the tooth 2304. A target magnet 2323 is configured to be attached to the lingual or palatal side of the crown 2303 of the target tooth 2304. The magnet based orthodontic appliance system 2301 includes a rigid support arch 2300 (only partially shown in cross-section) having a therapeutic magnet 2325 corresponding to and for magnetic attraction to the target magnet 2323. In the illustrated embodiment, the support arch 2300, therapeutic magnet 2325 and the target magnet 2323 are configured to be horizontally aligned with the crown 2303 of the target tooth 2304, so that the force 2350 of the magnetic interaction between the therapeutic magnet 2325 and target magnet 2323 are occlusal to a center of resistance 2306 to movement located on the root 2305 of the tooth 2304. A stop 2336 on the therapeutic magnet 2325 would eventually prevent direct approximation of the therapeutic magnet 2325 and the target magnet 2323.

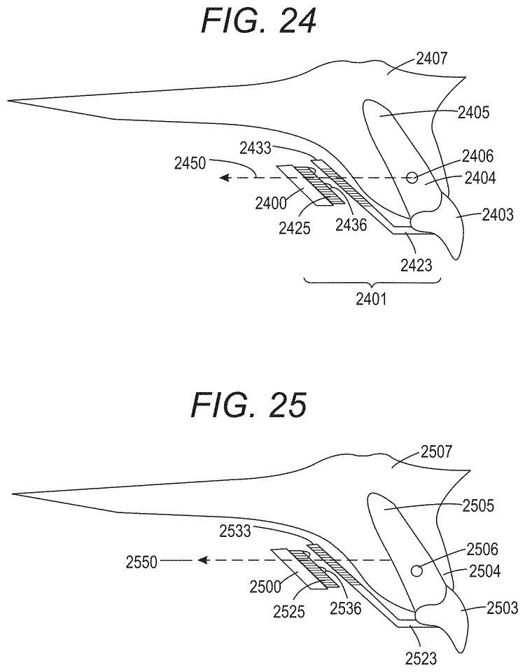

Embodiments including extended target magnets will now be described. For instance, FIG. 24 provides a cross-sectional view of a target tooth 2404 along with a bony palate 2407 of a patient in relation to a cross-sectional view of a magnet based orthodontic appliance system 2401 that might be used for retraction of the target tooth 2404 using an extended target magnet 2423. The target magnet 2423 is configured to be attached to the lingual or palatal side of a crown 2403 of the target tooth 2404. However, unlike the embodiment of FIG. 23, the target magnet 2423 is L-shaped and includes a first portion or shorter leg configured to extend briefly lingually away from the crown of the tooth 2404 and a second portion or longer leg that extends upward (as viewed in the figure) at an obtuse angle from the first portion and approximating a local contour of the bony palate 2407 until a distal end of the second portion reaches a bit beyond a vertical location of a center of resistance 2406, located in the root 2405 of the target tooth 2404. FIG. 23 is illustrative, as are all the FIGS. In some applications a target magnet corresponding to target magnet 2423 might have a different shape. For instance, an angle between the first and second leg might not be obtuse. In some situations, there may not be a definite distinction between the first and the second leg, the target magnet might be substantially linear and a region corresponding to the second leg might extend from a first region which is attached to the lingual or palatal surface of the tooth. The magnet based orthodontic appliance system 2401 includes a rigid support arch 2400 (only partially shown in cross-section) having a therapeutic magnet 2425 corresponding to and for magnetic attraction to the target magnet 2423. In the illustrated embodiment, the rigid support arch 2400, therapeutic magnet 2425 and the distal end of the second portion or longer leg of the target magnet 2423 are aligned in line horizontally with the center of resistance 2406 of the target tooth 2404, so that the force formed due the magnetic interaction between the therapeutic magnet 2425 and target magnet 2423 acts along a horizontal line 2450 through the center of resistance 2406 allowing translation of the tooth 2404, rather than applying a tipping or pivoting torque. One or more stops 2436 on the therapeutic magnet 2425 would prevent eventual direct approximation of the therapeutic magnet 2425 and the target magnet 2423 during the course of treatment.

FIG. 25 provides a cross-sectional view of a target tooth 2504 along with a bony palate 2507 of a patient in relation to a cross-sectional view of a magnet based orthodontic appliance system 2501 that might be used for torqueing or lingual root movement of the target tooth 2504 using an extended target magnet 2523. The target magnet 2523 is L-shaped and includes a first portion configured to extend briefly lingually away from the crown 2503 of the target tooth 2504 and a longer portion that extends upward at an obtuse angle from the first portion and approximating a local contour of the bony palate 2507 until a distal end of the second portion reaches a beyond a vertical location of a center of resistance 2506 of the target tooth 2504, located in a root 2505 of the target tooth 2504. In some applications a target magnet corresponding to target magnet 2523 might have a different shape. For instance, an angle between the first and second leg might not be obtuse. In some situations, there may not be a definite distinction between the first and the second leg, the target magnet might be substantially linear and a region corresponding to the second leg might extend from a first region which is attached to the lingual or palatal surface of the tooth. The magnet based orthodontic appliance system 2501 includes a rigid support arch 2500 (only partially shown in cross-section) having a therapeutic magnet 2525 corresponding to and for magnetic attraction to the target magnet 2523. In the illustrated embodiment, the support arch 2500, therapeutic magnet 2525 and the longer portion of the target magnet 2523 are aligned horizontally at a point above (as viewed in the figure), or closer to, the root end of the target tooth 2504 that the center of resistance 2506 of the target tooth 2504, so that a force formed due the magnetic interaction between the therapeutic magnet 2525 and target magnet 2523 acts along a horizontal line 2550 above or beyond the center of resistance 2506 at the point that is closer to the root end of the target tooth 2504 allowing more retraction of the root 2505 than the crown 2503 of the tooth 2504. Stops 2536 on the therapeutic magnet 2525 would prevent direct approximation of the therapeutic magnet 2525 and the target magnet 2523 during the course of treatment.

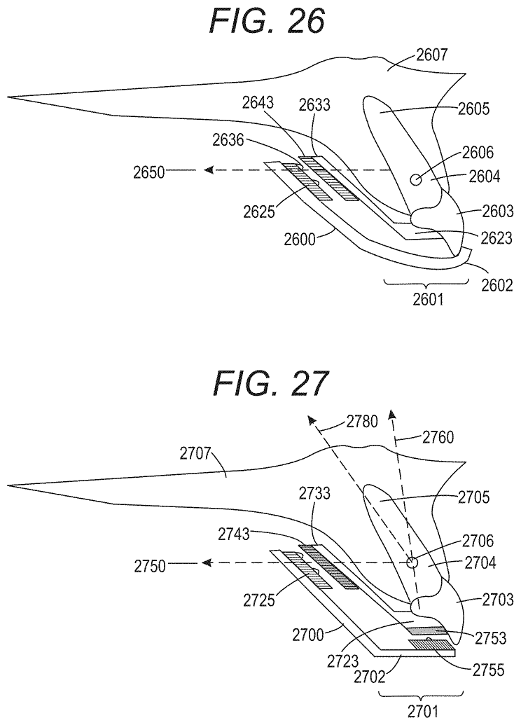

FIG. 26 provides a cross-sectional view of a target tooth 2604 along with a bony palate 2607 of a patient in relation to a magnet based orthodontic appliance system 2601 that might be used for torqueing or lingual root movement of the target tooth 2604 using an extended target magnet 2623. The extended target magnet 2623 is configured to be attached to the lingual or palatal side of the crown 2603 of the target tooth 2604. In the illustrated embodiment, the target magnet 2623 is L-shaped and includes a first or shorter portion configured to extend briefly lingually away from the crown 2603 of the target tooth 2604 and a longer or second portion that extends upward at an obtuse angle from the first or shorter portion while approximating a local contour of the bony palate 2607 until a distal end of the longer portion reaches a point beyond a vertical location of a center of resistance 2606 of the target tooth 2604 located in the root 2605 of the target tooth 2604. The magnet based orthodontic appliance system 2601 includes a rigid support arch 2600 (only partially shown in cross-section) having a therapeutic magnet 2625 corresponding to and for magnetic attraction to the target magnet 2623. The rigid support arch 2600 could be extended to all front teeth or only teeth that need the extension. In the illustrated embodiment, the therapeutic magnet 2625 and an additional magnet 2643 located at the distal end of the second portion of the extension 2633 of the target magnet 2623 are horizontally aligned at a point above (as viewed in the figure) the center of resistance 2606, at a point closer to the root end of the target tooth 2604, so that a therapeutic magnetic force 2650 formed due a magnetic interaction between the therapeutic magnet 2625, the target magnet 2623 and the additional magnet 2643 would act at a point above the center of resistance 2606, which is closer to the root end of the tooth 2604, thereby, for example, urging more retraction of the root 2605 than the crown 2603 of the target tooth 2604. The additional magnet 2643 can be included to modulate the strength of the therapeutic magnetic force 2650. At least one stop 2636 on the therapeutic magnet 2625 would prevent direct approximation of the therapeutic magnet 2625 and the additional magnet 2643 during the course of treatment. The rigid support arch 2600 includes a labial stop 2602 that is configured to grasp a front edge of the crown 2603 of the target tooth 2604 so that the forward movement of the crown 2603 is prevented.

FIG. 27 provides a cross-sectional view of a tooth 2704 along with a bony palate 2707 of a patient in relation to a cross-sectional view of a magnet based orthodontic appliance system 2701 that might be used for intrusion of a target tooth 2704 along a long axis of the target tooth 2704 using an extended target magnet 2723. In the illustrated embodiment, the target magnet 2723 is configured to be attached to the lingual or palatal side of a crown 2703 of the target tooth 2704. The illustrated target magnet 2723 is L-shaped and includes a first or shorter portion configured to extend briefly lingually away from an attachment point on the crown 2703 of the target tooth 2704, and a second or longer portion that extends upward at an obtuse angle from the first portion while approximating a local contour of a bony palate 2707 of the patient until a distal end of the second portion reaches a bit beyond a vertical location of a center of resistance 2706 of the target tooth 2704, located in the root 2705 of the target tooth 2704. The target magnet 2723 is configured to support a first additional magnet 2743 and a second additional magnet 2753. The first additional magnet 2743 is supported at a distal end of the second portion of the target magnet, a portion of which is intersected by a horizontal line through the center of resistance 2706 of the target tooth 2704. Accordingly, a portion of the first additional magnet is also intersected by the horizontal line (e.g., see 2750). In the illustrated embodiment, the second additional magnet 2753 is supported by the target magnet 2723 at a point on the first extension wherein portions of the target magnet 2723 and the second additional magnet 2753 are intersected by a vertical line (e.g., see 2760) that also goes through the center of resistance 2706 of the target tooth 2704.

The magnet based orthodontic appliance system 2701 includes a rigid support arch 2700 (only partially shown in cross-section) configured to support a therapeutic magnet 2725 corresponding to and for magnetic attraction to the first additional magnet 2743 on the target magnet 2723. The rigid support arch 2700 could be extended to all front teeth or only teeth that need the extension. In the illustrated embodiment, the therapeutic magnet 2725 and the first additional magnet 2743 are configured to produce an attractive magnetic force and are horizontally aligned with the center of resistance 2706 of the target tooth 2704, so that an attractive force 2750 formed due the magnetic attraction between the therapeutic magnet 2725 and additional magnet 2723 acts horizontally through the center of resistance 2706 of the tooth 2704 to urge/pull the tooth backward. At least one stop 2736 on the therapeutic magnet 2725 is shown in direct contact with the first additional magnet 2743 on the target magnet 2723 to prevent lingual retraction of the target tooth 2704 beyond the stop 2736.

The rigid support arch 2700 includes an L-shaped extension 2702, a first or longer portion of which extends downward (in the illustration) in a direction generally parallel to the second portion of the extended target magnet 2723 to a point below (in the illustration) a level of the second additional magnet 2753 on the target magnet 2723. At the point below the level of the second additional magnet 2753, a second and shorter portion of the L-shaped extension 2702 extends away from the first portion of the support arch extension 2702 at an obtuse angle and generally parallel to the second additional magnet 2753 and first or shorter portion of the target magnet 2723 to a point behind the crown 2703 of the target tooth 2704 and approximately aligned with the attachment end of the first portion of the target magnet 2723 where the target magnet 2723 is bonded to the crown 2703 of the target tooth 2704. The second or shorter portion of the L-shaped extension 2702 of the rigid support arch 2700 supports an additional therapeutic magnet 2755 which is configured to produce a repulsive force with the second additional magnet 2753 on the target magnet 2723. The additional therapeutic magnet 2755 and the second additional target magnet 2753 are aligned with the center of resistance 2706 in the vertical plane (see 2760) so that the associated generated repulsive force 2760 would urge the target tooth 2704 in an upward (relative to the figure) vertical direction along the center of resistance 2706. For instance, the magnets are configured (e.g., by selection of size, strength, location and spacing) so that the two force vectors 2750 and 2760 form a resultant 2780 force vector which is directed along the long axis of the tooth 2704 resulting in true intrusion along the long axis of the tooth. As the tooth is urged into the bone along vector 2780 the space between the magnets 2753 and 2755 increases, in order to maintain the same repulsive force levels, a new support arch and associated attachments could be inserted or one of the magnets could be modified as explained in FIG. 22.

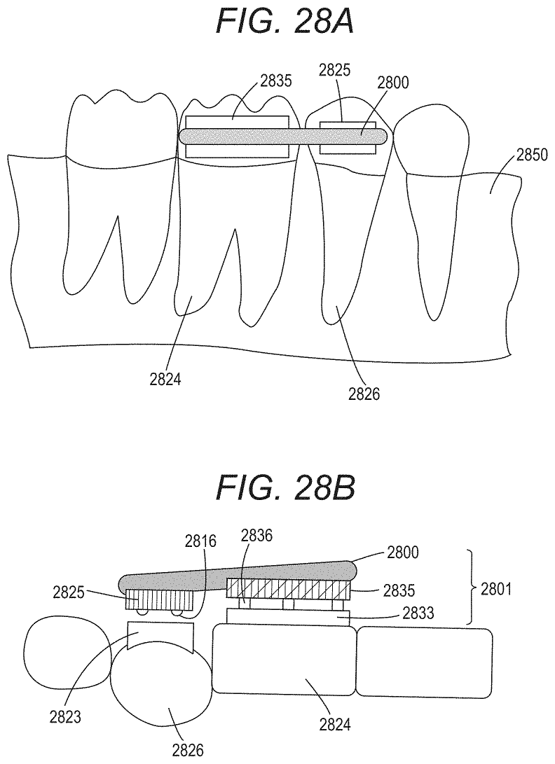

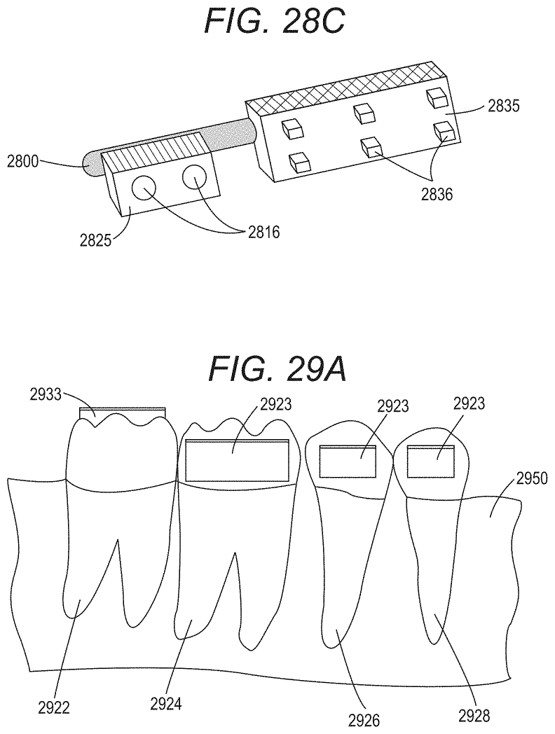

Embodiments discussed thus far have included multiple support teeth, multiple first docking components (e.g., attachment magnets) and multiple second docking components (e.g., mounting magnets). However, it is to be understood, that in some scenarios, only a single support tooth is needed or available. For instance, FIG. 28A-C illustrate a magnet-based orthodontic appliance system 2801 that includes one attachment magnet 2833 configured to be attached to the lingual or palatal side of a support tooth 2822 of a set of teeth 2850. The magnet based orthodontic appliance system 2801 includes a rigid support arch 2800 which is configured to support or include one mounting magnet 2835 corresponding to and for magnetic attraction to the attachment magnet 2833. The rigid support arch 2800 is secured in position by attractive magnetic forces between the mounting magnet 2835 and the attachment magnet 2833. The mounting magnet 2835 includes stops 2836 which are configured to prevent direct approximation of the mounting magnet 2835 and the attachment magnet 2833.

The rigid support arch 2800 is also configured to support a therapeutic magnet 2825 at a therapeutic position corresponding to a target magnet 2823 attached to the lingual or palatal side of a target tooth 2826. The therapeutic magnet 2825 also has at least one or more stop 2816 which will prevent direct contact (direct approximation) between the facing surfaces of the therapeutic magnet 2825 and target magnet 2823 as the target tooth 2826 moves towards the rigid support arch 2800 due to the attractive forces between the therapeutic magnet 2825 and target magnet 2823.

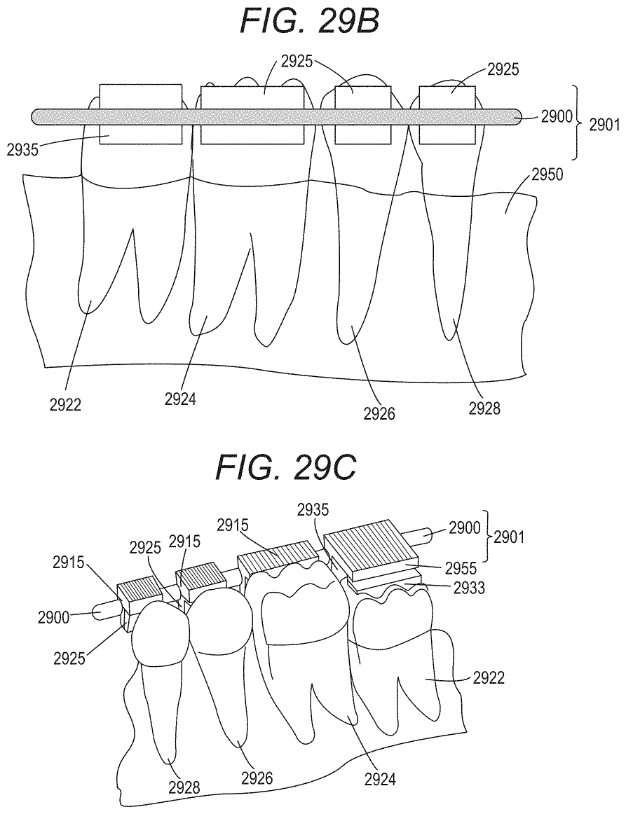

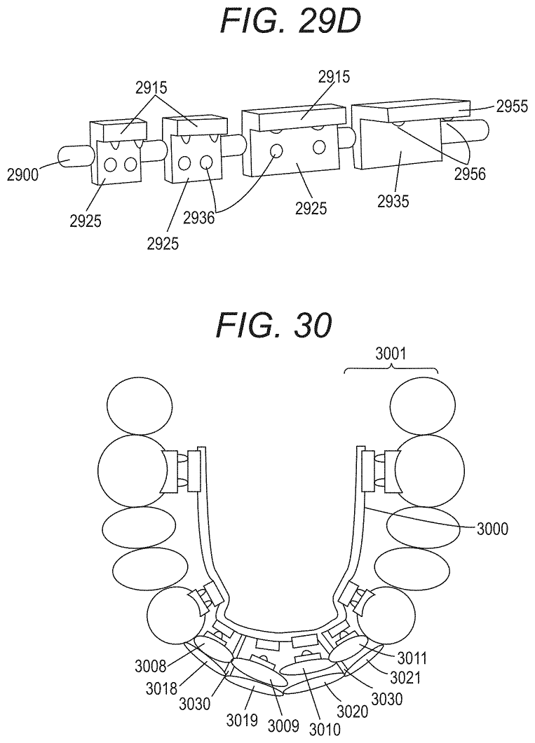

In the embodiment of FIGS. 29A-D a magnet-based orthodontic appliance system 2901 includes at least one first docking component, such as an attachment magnet 2923 configured to be attached to the lingual side of at least one respective support tooth 2924, 2926 and 2928. The magnet based orthodontic appliance system 2901 includes a rigid support arch 2900 having a respective at least one second docking component, such as mounting magnet 2925 corresponding to and for magnetic attraction to the at least one attachment magnets 2923. The rigid support arch 2900 is secured in position by the attractive magnetic forces between the mounting magnets 2925 and attachment magnets 2923. For example, the rigid support arch is made of orthodontic wire or metallic rod of appropriate size and rigidity. For example, in some applications, the wire or rod commonly used in orthodontic headgear may provide sufficient rigidity. Rod or wire with a diameter of about 0.045 to about 0.06 inches or more may be appropriate. In some applications, thinner wire may suffice. Other embodiments might be injection molded or cast plastic or 3D printed (made through additive manufacturing). Machined embodiments are also possible. The mounting magnets 2925 include horizontal extensions 2915 that are configured to extend from the mounting magnets 2925 over a second or top face (as viewed in the figures) of their respective attachment magnet 2923. At least one stop 2936 on the at least one mounting magnet 2925 contacts the lingual and occlusal surface of the at least one of the attachment magnets 2923 and prevents lingual and occlusal movement of the support teeth 2924, 2926 and 2928, due to the attractive magnetic forces between the mounting magnets 2925 and the attachment magnets 2923.

The rigid support arch 2900 is configured to support a therapeutic magnet 2935 at a therapeutic position corresponding to a target magnet 2933 attached to the occlusal surface of a target tooth 2922. The therapeutic magnet 2935 has a horizontal extension 2955 that extends over top surface of the target magnet 2933, which results in, for example, an attractive force in a vertical plane to urge the tooth 2922 away from the bone so that the tooth 2922 comes in a horizontal level with the support teeth 2924, 2926 and 2928. The therapeutic magnet 2935 also includes at least one stop 2956 on the horizontal extension 2955 in order to prevent direct approximation of the facing surfaces of the horizontal extension 2955 and the target magnet 2933.

In the embodiment of FIG. 30, the magnet based orthodontic appliance system 3001, has a rigid support arch 3000, configured to change the position of teeth 3008, 3009, 3010 and 3011. The support arch has extensions 3030 which hold labial veneers 3018, 3019, 3020 and 3021 which are connected to each other, while mimicking the final position of the teeth 3008, 3009,3010 and 3011.

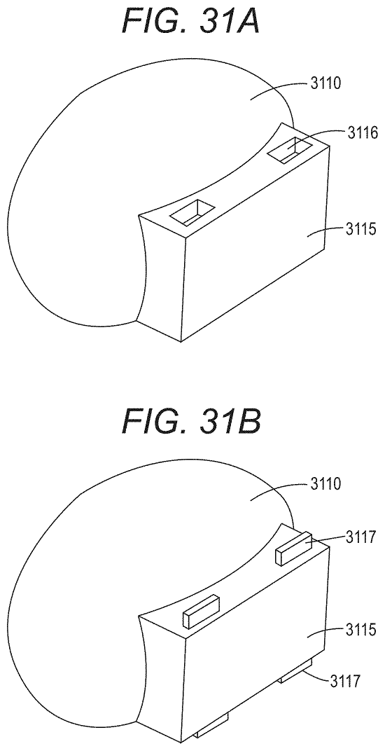

In the embodiment of FIGS. 31A-B, attachment 3115 on the tooth 3110 presents with one or more notches 3116 or one or more flanges, to facilitate gripping of the attachments while debonding from the tooth surface.

It should be appreciated that the presently described embodiments include methods for use, operation, and/or implementation of the appliances, devices and systems described herein to perform, for example, functions, such as those described in connection with the embodiments of FIGS. 1A-31B and below, to implement orthodontic techniques or procedures to resolve a variety of orthodontic issues. The implementation of any one of the presently described embodiments, including use, operation, and/or implementation of the appliances, devices and systems and/or associated methods to perform desired functions, achieves a variety of functions and results which have advantages and benefits over conventional technology and/or are not achievable by conventional technology.

At least some of these are described above. In addition, as a further example, traditionally, orthodontic appliances like removable appliances, fixed appliances using a combination of brackets and arch wires, and clear aligners using thermoplastic material, apply force on the crown of the teeth to move them in the bone. Hence, the applied force is away from the center of resistance of the teeth. The center of resistance of each individual tooth is located on the root of the tooth or within the confines of the roots in case of a multirooted tooth. The applied force, which is away from the center of resistance, produces a rotational tendency, leading to rotational movement of the tooth/teeth around a center of rotation located on the tooth root. Although various measures are employed to counter this rotational tendency, none of the appliances that have been used for orthodontic tooth movement have been able to generate adequate counter moments in the labio-lingual plane (in-out plane). Hence, the teeth tend to tip lingually (inward) during the initial movement wherein the crown of the teeth move ahead of the root, and additional steps are required to move the roots in order to obtain optimal labio-lingual (in-out) inclination.

According to at least some forms of the presently described embodiments, the magnet based orthodontic appliance system is configured, unlike conventional technology, to cause or obtain adequate counter moments while in use or operation, while moving the teeth lingually. The counter moment generated is a function of the vertical heights of the therapeutic magnet and the target magnet or the length of the extension arm which extends towards the center of resistance of the tooth so that the applied force is in line with the center of resistance of the tooth.

Also, according to at least some forms of the presently described embodiments, the appliance system is configured, unlike conventional technology, to cause, while in use or operation, precise tooth movement without undue side effects on the adjacent teeth, as movement of each tooth is independent of the movement of the adjacent tooth. This is possible as the teeth movement is carried out by forces which are generated by magnetic interaction of magnets or ferromagnetic material held on a rigid support arch and the magnets or ferromagnetic material attached on the teeth that required to be moved. This is in contrast to the mechanics employed by traditional fixed appliances and clear aligners which are dependent on arch wires or thermoplastic material that could flex and create undesirable side effects on the adjacent teeth while a tooth is being moved.

While features, aspects, options and components have been described or illustrated in association with particular embodiments, it is to be understood that those features, aspects, options or components are not restricted to those embodiments. To the contrary, features, aspects, options or components described or illustrated in one embodiment can be included in other embodiments. Additionally, features, aspects, options or components described in association with an embodiment can be deleted from that embodiment to arrive at an embodiment including remaining and/or alternative features, aspects, options or components.

The exemplary embodiment has been described with reference to the preferred embodiments. Modifications and alterations will occur to others upon reading and understanding the preceding detailed description. It is intended that the exemplary embodiment be construed as including all such modifications and alterations insofar as they come within the scope of the appended claims or the equivalents thereof.

1. An orthodontic appliance system comprising:
at least one first docking component configured to be attached to the lingual or palatal side of at least one respective support tooth;
at least one target magnet, the at least one target magnet comprising at least one of a magnet or paramagnet, the at least one target magnet being configured to be attached to at least one of a lingual, palatal, distal or mesial surface of at least one respective target tooth, at least one point on a bony palate and/or at least one point on a buccal bone;
a rigid support arch having respective at least one second docking component corresponding to, and for securement to, the at least one first docking component, the rigid support arch being configured to support at least one therapeutic magnet at at least one respective therapeutic position adjacent a respective one of the at least one target magnet;
wherein the at least one of the rigid support arch, at least one of the at least one target magnet or at least one of the at least one therapeutic magnet includes at least one stop configured to prevent or limit an aspect of movement of a tooth.

2. The orthodontic appliance system of claim 1 wherein the rigid support arch comprises an orthodontic wire.

3. The orthodontic appliance system of claim 1 wherein the rigid support arch comprises a metal band.

4. The orthodontic appliance system of claim 1 wherein the rigid support arch comprises a thermoplastic appliance.

5. The orthodontic appliance system of claim 1 wherein the rigid support arch comprises a resin-based appliance.

6. The orthodontic appliance system of claim 1 wherein the rigid support arch comprises a rigid thermoplastic or resin.

7. The orthodontic appliance system of claim 1 wherein at least one of the at least one target or at least one of the at least one therapeutic magnet has a non-planar shape.

8. The orthodontic appliance system of claim 7 wherein the non-planar shape comprises an L-shape.

9. The orthodontic appliance system of claim 8 wherein the L-shape comprises an obtuse angle between legs of the L-shape.

10. The orthodontic appliance system of claim 7 wherein the non-planar shape comprises one of a C-shape and a U-shape in cross section from an occlusal view.

11. The orthodontic appliance system of claim 1 wherein at least one target of the at least one target comprises an extended target that is larger in at least one dimension than a corresponding dimension of an exposed portion the at least one associated target tooth.

12. The orthodontic appliance system of claim 1 wherein the at least one stop comprises a first stop and a second stop, the first stop being configured to make an initial contact during a therapeutic movement of a tooth, thereby limiting a first aspect of the therapeutic movement the tooth, while the second stop has not yet made a contact, thereby allowing a second aspect of therapeutic movement of the tooth.

13. The orthodontic appliance system of claim 1 wherein the rigid support arch includes at least one extension configured to extend into a space left by an extracted or missing tooth and the at least one therapeutic magnet includes at least one therapeutic magnet mounted on the at least one extension and the at least one target magnet includes at least one target magnet mounted on at least one mesial or distal surface of at least one target tooth adjacent the space left by the extracted or missing tooth.

14. The orthodontic appliance system of claim 13 wherein the at least one extension that is configured to occupy the space left by an extracted or missing tooth comprises a tooth shaped pontic.

15. The orthodontic appliance system of claim 1 wherein the rigid support arch supports at least one non-magnetic guide plane configured to provide a supplemental contact-based guidance to urge a tooth in a desired direction.

16. The orthodontic appliance system of claim 1 wherein the rigid support arch wherein at least one of the at least one target magnet and at least one of the at least one therapeutic magnet are configured to have opposite poles facing each other while at least one of the at least one target magnet and the at least one therapeutic magnet include at least one stop configured to prevent movement of the target tooth toward the therapeutic magnet.

17. The orthodontic appliance system of claim 8 wherein the L-Shaped magnet is configured to urge the target tooth occlusally, lingually and/or laterally.

18. The orthodontic appliance system of claim 1 wherein at least one of the at least one target magnet and the at least one therapeutic magnet supports at least a first stop and a second stop, the first stop being configured to contact the other of the at least one target magnet and the at least one therapeutic magnet during a therapeutic time period before the second stop contacts the other of the at least one target magnet and the at least one therapeutic magnet, thereby providing a pivot point for achieving a desired movement of an associated target tooth.

19. The orthodontic appliance system of claim 1 wherein the at least one target magnet and the at least one therapeutic magnet comprise complementary triangular shapes whereby respective hypotenuses of the triangular shapes can be configured to face each other.

20. The orthodontic appliance system of claim 1 wherein the at least on target magnet comprises a first target magnet and a second target magnet configured to be attached to a lingual or palatal side of a same respective target tooth and wherein the rigid support arch is configured to support a first therapeutic magnet and a second therapeutic magnet adjacent the same respective target tooth, wherein the first target magnet and the first therapeutic magnet are configured to produce an attractive force therebetween and the second target magnet and the second therapeutic magnet are configured to produce a repulsive force therebetween.

21. The orthodontic appliance system of claim 1 wherein at least one of the at least one therapeutic magnet is configured to include a substantially horizontal lever arm longer than the width of an associated target tooth.

22. The orthodontic appliance system of claim 21 wherein the substantially horizontal lever arm supports a magnetic attachment at a distal end thereof.

23. The orthodontic appliance system of claim 1 wherein the rigid support arch includes at least one occlusal extension configured to apply intruding forces to at least one tooth.

24. The orthodontic appliance system of claim 1 wherein the rigid support arch includes at least one sagittal stabilization stop configured to contact a rear surface of a respective at least one attachment magnet and limit forward movement of the rigid support arch.

25. The orthodontic appliance system of claim 1 wherein the at least one first and the at least one second docking components comprise respective at least one attachment and at least one mounting magnet.

26. The orthodontic appliance system of claim 25 wherein the at least one first docking component comprises at least one set of conjoined attachment magnets.

27. The orthodontic appliance system of claim 25 wherein at least one of the at least one mounting magnet includes a horizontal extension configured to extend from the at least one mounting magnet to an area adjacent a second face of a respective attachment magnet.

28. The orthodontic appliance system of claim 27 wherein the horizontal extension includes at least one stop on the horizontal extension configured to prevent vertical movement of an associated support tooth due to attractive magnetic force between the at least one mounting magnet including the horizontal extension and the attachment magnet.

29. The orthodontic appliance system of claim 25 wherein at least one of the at least one therapeutic magnet includes a horizontal extension configured to extend from the at least one therapeutic magnet to an area adjacent to and approximating a second face of a respective target magnet.

30. The orthodontic appliance system of claim 29 wherein the horizontal extension includes a first stop and a second stop on a surface of the horizontal extension approximating the second face of the target magnet, wherein the first stop is configured to be positioned at a point that is closer to the top surface of the target magnet that the second stop, thereby limiting vertical movement of the corresponding side of the target magnet relative to a side of the target magnet corresponding to a location of the second stop.

31. The orthodontic appliance system of claim 1 wherein the rigid support arch comprises at least one of orthodontic rod, orthodontic wire, injection molded plastic, cast plastic and 3D printed material including ferromagnetic material.

32. The orthodontic appliance system of claim 1 comprising a transpalatal arch connecting one or more attachment magnets from either side of the rigid support arch.

33. The orthodontic appliance system of claim 1 wherein the rigid support arch is configured to follow the contour of a palate of a patient.

34. The orthodontic appliance system of claim 33 wherein at least one of the at least one target is configured to be mounted on an implant configured to be implanted in the bony palate.

35. The orthodontic appliance system of claim 34 wherein the rigid support arch comprises occlusal extensions configured to cover and transmit therapeutic force between the at least one target magnet and at least one therapeutic magnet to at least one target tooth.

36. The orthodontic appliance system of claim 1 wherein at least one of the at least one target magnet is configured to be mounted on an implant configured to be implanted in the buccal bone.

37. The orthodontic appliance system of claim 36 wherein the rigid support arch is configured to support a horizontal extension, the horizontal extension being configured to contact an occlusal surface between teeth.

38. The orthodontic appliance system of claim 36 wherein the rigid support arch is configured to support a distal extension, the distal extension being configured to contact an occlusal surface of one of the at least one respective support tooth and further extend as a buccal extension to embrace a buccal surface of the one of the at least one respective support tooth and support a stabilizing magnet at a position adjacent to at least one stabilizing implant magnet mounted on a stabilizing implant implanted in the buccal bone.

39. The orthodontic appliance system of claim 8 wherein at least one therapeutic magnet is L-shaped and one leg of the L-shaped magnet comprises a horizontal extension of the at least one therapeutic magnet the horizontal extension comprising a stop configured to initially be spaced from a mesial surface of one of the at least one target magnet and to be contacted by the mesial surface of the one of the at least one target magnet only after a therapeutic mesial movement of the target tooth associated with the one of the at least one target magnet.

40. The orthodontic appliance system of claim 39 wherein at least one mounting magnet is L-shaped and one leg of the L-shaped magnet comprises a horizontal extension of the at least one therapeutic magnet the horizontal extension comprising a stop configured to initially contact a mesial surface of one of the at least one attachment magnet thereby preventing mesial movement of the support tooth associated with the one of the at least one attachment magnet.

41. The orthodontic appliance system of claim 36 wherein the rigid support arch comprises a horizontal extension configured to reach through a space between teeth to support at least one stabilizing implant magnet at a stabilizing position corresponding to a stabilizing implant magnet configured to be mounted on an implant implanted in a buccal bone.

42. The orthodontic appliance system of claim 41 wherein the horizontal extension is configured to abut a surface of a tooth, thereby providing further stabilization.

43. The orthodontic appliance system of claim 1 wherein at least one of the at least one attachment magnet includes a seat configured to receive a guide key extending from an associated mounting magnet.

44. The orthodontic appliance system of claim 1 wherein at least one of the at least one mounting magnet includes a guide key configured to be received in a seat included in an associated attachment magnet.

45. The orthodontic appliance system of claim 1 wherein the rigid support arch comprises at least one of a permanent magnet in the form of an arch shaped strip and an arch shaped strip including isolated magnetized regions.

46. The orthodontic appliance system of claim 45 wherein at least one of the at least one therapeutic magnet comprises a therapeutic magnet extension configured to face a mesial side or a distal side of at least one of the at least one target magnet.

47. The orthodontic appliance system of claim 1 wherein at least one of the at least one mounting magnet is L-shaped due to inclusion of a horizontal mounting extension configured to provide a mesio-distal support force.

48. The orthodontic appliance system of claim 1 wherein the horizontal mounting extension includes at least one stop for opposing mesio-distal movement of at least one associated support tooth.

49. The orthodontic appliance system of claim 1 wherein the rigid support arch is configured to be located gingival to the crowns of teeth of an associated patient and wherein the at least one mounting magnet and the at least one therapeutic magnet are attached to the rigid support arch by vertical extensions from the rigid support arch.

50. The orthodontic appliance system of claim 1 wherein the rigid support arch, at least one mounting magnet and the at least one therapeutic magnet are a single unitary manufacture.

51. The orthodontic appliance system of claim 25 wherein the rigid support arch comprises an upper rigid support arch and the at least one mounting magnet comprises at least one upper mounting magnet, at least one of the at least one upper mounting magnet comprising a downward extension, the orthodontic appliance system further comprising:
a lower rigid support arch having at least one lower mounting magnet, at least one of the at least one lower mounting magnet comprising an upward extension;
wherein extensions of respective at least one pair of the downward extension of the at least one upper mounting magnet and the upward extension of the at least one lower mounting magnet are configured to magnetically attract one another when installed in an associated patient, thereby urging an upper dental arch and a lower dental arch of the associated patient toward one another in an antero-posterior direction.

52. The orthodontic appliance system of claim 25 wherein at least one of the at least one attachment magnet and at least one mounting magnet comprise a stop.

53. The orthodontic appliance system of claim 25 wherein the rigid support arch and at least one of the at least one therapeutic magnet and at least one mounting magnet comprise at least one set of interlocking portions.

54. The orthodontic appliance system of claim 53 wherein the interlocking portions comprise at least one half-blind dovetail in the rigid support arch and a dovetail pin in the at least one of the at least one therapeutic magnet and at least one mounting magnet.

55. The orthodontic appliance system of claim 32 wherein at least one of the attachment magnets on either side of the rigid support arch and connected by the transpalatal arch is a wide attachment magnet configured to be attached to two or more support teeth.

56. The orthodontic appliance system of claim 43 wherein the at least one of the at least one attachment magnet includes at least one a spring clip configured to participate in retaining the guide key in the seat.

57. The orthodontic appliance system of claim 56 wherein the at least one of the at least one attachment magnet includes a door that is configured to be securable under the at least one spring clip and over the seat, thereby being configured to participate in retaining the guide key in the seat.

58. The orthodontic appliance system of claim 56 wherein the at least one spring clip comprises two spring clips configured to be installed on either side of the seat and wherein the guide key includes a stabilization member including a first arm and a second arm that extend out in two opposite directions perpendicular to a top surface of a distal end of the guide key, thereby forming a T-shape, the stabilization member being configured to rest on a top surface of the attachment magnet when the guide key is in the seat, and wherein the spring clips are configured to capture the first arm and the second arm of the stabilization member respectively.

59. The orthodontic appliance system of claim 1 wherein at least one of the at least one therapeutic magnet includes a slot or pocket configured to accept one or more additional magnets.

60. The orthodontic appliance system of claim 1 comprising at least one additional magnet.

61. The orthodontic appliance system of claim 8 wherein at least one of the at least one target magnet comprises the L-shape with an angle between a shorter leg and a longer leg of the L-shape wherein the shorter leg is configured to be bonded to and extend briefly lingually away from the crown of an associated target tooth of an associated patient and the longer leg is configured to extend, at an angle, away from the shorter leg, approximating a local contour of a bony palate of the associated patient until a distal end of the longer leg reaches a bit beyond a vertical location of a center of resistance in a root of the target tooth; and wherein
the rigid support arch is configured to support a therapeutic magnet corresponding to and for magnetic attraction to the target magnet at the distal end of the longer leg of the target magnet at a point centered on and horizontally aligned in line with the center of resistance of the associated target tooth, whereby a force formed due the magnetic interaction between the therapeutic magnet and target magnet would act in a direction horizontally through the center of resistance.

62. The orthodontic appliance system of claim 61 wherein the rigid support arch includes an extension configured to grasp a front edge of the crown of the associated target tooth.

63. The orthodontic appliance system of claim 61 further comprising:
at least one of a first and/or second additional magnet and an L-shaped extension of the rigid support arch, wherein the first additional magnet is configured to be mounted on the distal end of the long leg of the target magnet, the second additional magnet being configured to be mounted on the short leg of the target magnet, the L-shaped extension of the rigid support arch having a longer leg extending from the rigid support arch generally parallel to the long leg of the target magnet and a short leg extending from a distal end of the long leg generally parallel to the short leg of the target magnet, the short leg of the extension of the rigid support arch supporting an auxiliary therapeutic magnet.

64. The orthodontic appliance system of claim 8 wherein at least one of the at least one target comprises the L-shape with an angle between a shorter leg and a longer leg of the L-shape wherein the shorter leg is configured to be bonded to and extend briefly lingually away from the crown of an associated target tooth of an associated patient and wherein the longer leg is configured to extend, at an angle, away from the shorter leg and approximating a local contour of a bony palate of the associated patient until a distal end of the longer leg reaches beyond a vertical location of a center of resistance in a root of the target tooth; and wherein
the rigid support arch is configured to support a therapeutic magnet corresponding to and for magnetic attraction to the target magnet at the distal end of the longer leg of the target magnet centered on and aligned horizontally in line with a point beyond the center of resistance, closer to root end of the target tooth, whereby a force formed due the magnetic interaction between the therapeutic magnet and target magnet would act in a direction horizontally through the center of resistance.

65. The orthodontic appliance system of claim 1, wherein the rigid support arch is configured to change the position of teeth and has extensions which hold labial veneers which are connected to each other thereby mimicking the final position of the teeth.
